(19) United States
(12) Patent Application Publication
(10) Pub. No.: US 2009/0150307 A1
(43) Pub. Date: Jun. 11, 2009

(54) Combinations

(76) Inventor: William George Bentz, Laurel, MD (US)

Correspondence Address: William G. Bentz, 8106 Shannon's Alley, Laurel, MD, 20724, US

(21) Appl. No.: 12/316,307

(22) Filed: Dec. 11, 2008

Related U.S. Application Data
(60) Provisional application No. 61/007,102, filed on Dec. 11, 2007.

(51) Int. Cl. G06Q 90/00

(52) U.S. Cl. 705/500

(57) ABSTRACT

A document may include a plurality of published references such as, for example, a published patent(s), a published patent application(s) and/or other published reference(s). The document includes a combination of (1) a first subject matter in view of (e.g., combined with and/or modified by) a second subject matter and/or (2) the first subject matter, the improvement comprising the second subject matter. The patent document discloses that any teaching or part thereof (e.g., at least a teaching or part thereof) from the published references may be applied as the first subject matter, and that any other teaching or part thereof (e.g., at least a different teaching or part thereof) from the published references may be applied as the second subject matter. FIGS. 6 and 7 illustrate examples of the combination.

This application claims the benefit of U.S. Provisional Application No. 61/007102, filed Dec. 11, 2007, which is hereby incorporated by reference in its entirety.

### DESCRIPTION OF BACKGROUND INFORMATION

According to BusinessWeek, the top 10 most innovative companies in the world (as of April 2006) are: Apple, Google, 3M, Toyota, Microsoft, General Electric, Procter & Gamble, Nokia, Starbucks and IBM. BusinessWeek has also reported that creativity pays, as evidenced by the market capitalization of each above-identified company.

Established companies (or others such as Venture Capitalists), thus, have an incentive to invest in startups (or others such as solo inventors) that innovate. Google (as of January 2006), for example, has already purchased twelve companies in the past three years, including five startups in the past six months alone. The ingenuity of an inventor(s) can propel a company, whether a “top 10” company, a startup or otherwise, to unimaginable growth, which Wall Street rewards. So, a need continues to exist for more innovations.

### BRIEF DESCRIPTION OF THE DRAWINGS

FIG. 1 depicts a specification of the present patent document;

FIGS. 2-7 depict a plurality of exemplary combinations;

FIGS. 8-31 depict a plurality of exemplary combinations of references to apply for the first incorporated reference, the second incorporated reference, the third incorporated reference and/or the fourth incorporated reference depicted in FIGS. 6 and/or 7;

FIGS. 32-34 depict a plurality of exemplary embodiments of methods;

FIG. 35 provides a table with an overview of the contents of a worldwide database from an esp@cenet service; and

FIG. 36 provides the “latest updates” of the worldwide database of FIG. 35, where the content (e.g., documents and cited references) of the worldwide database is incorporated by reference in its entirety herein.

### DETAILED DESCRIPTION

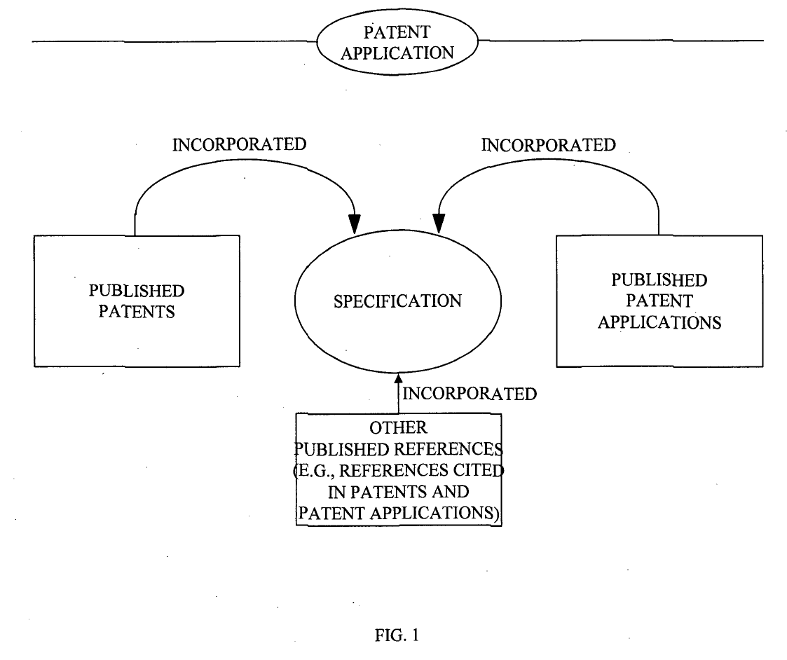

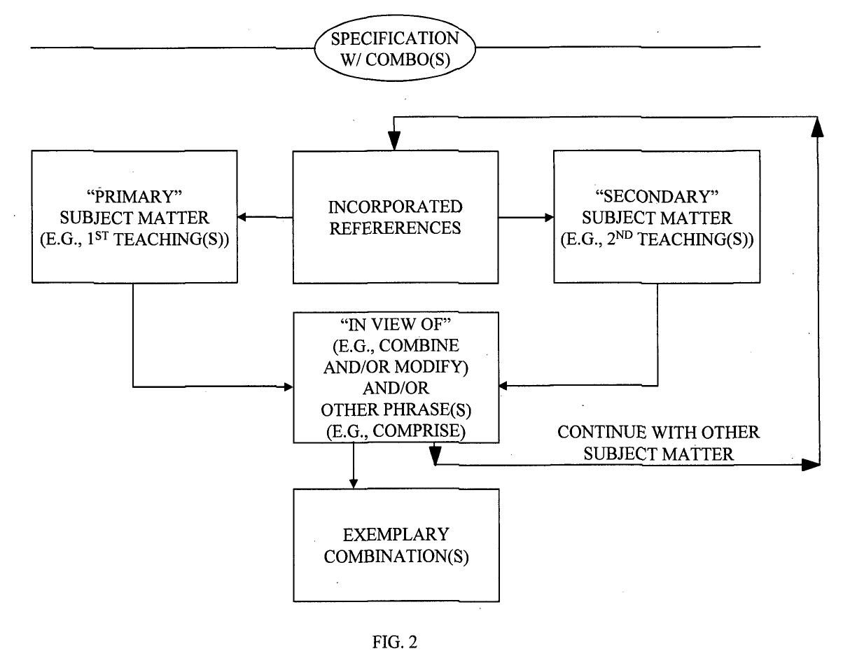

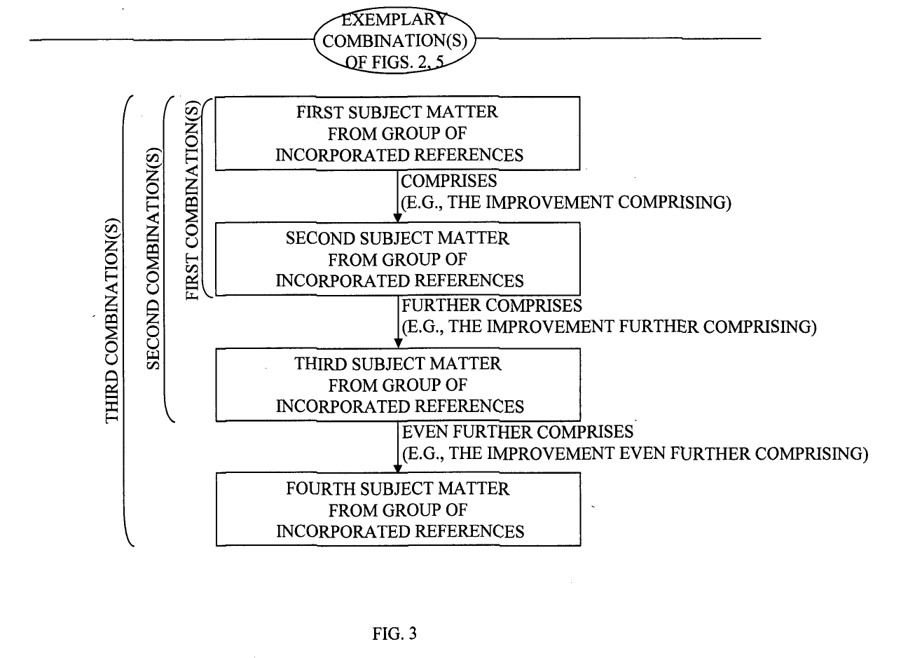

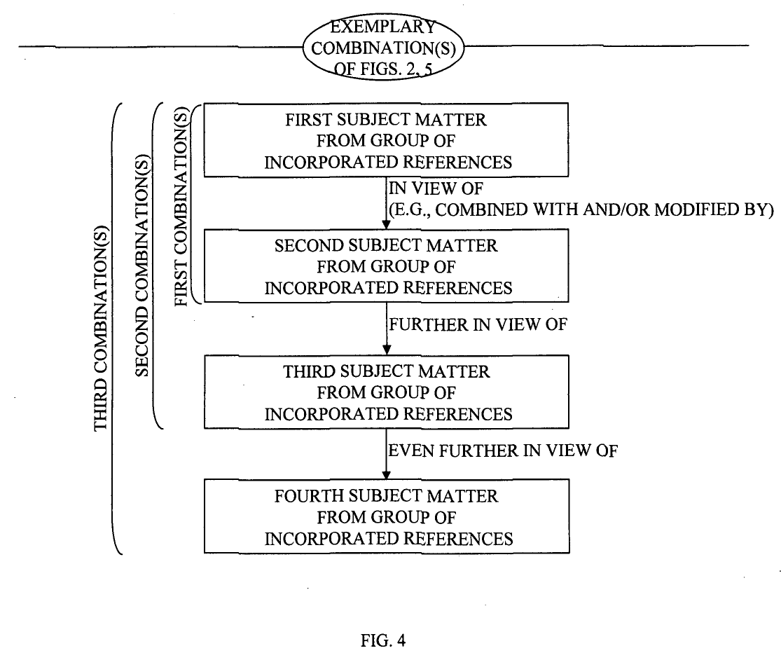

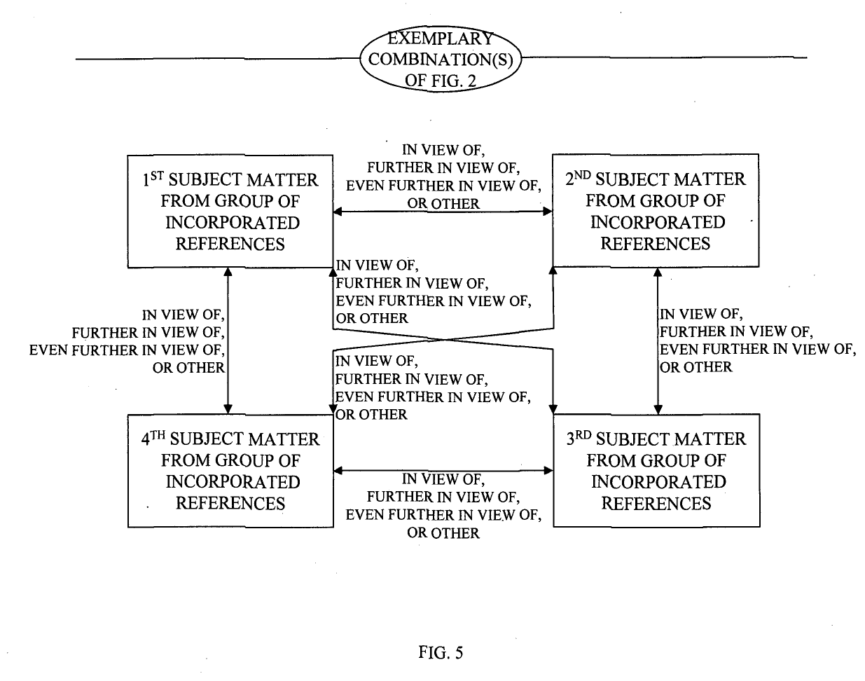

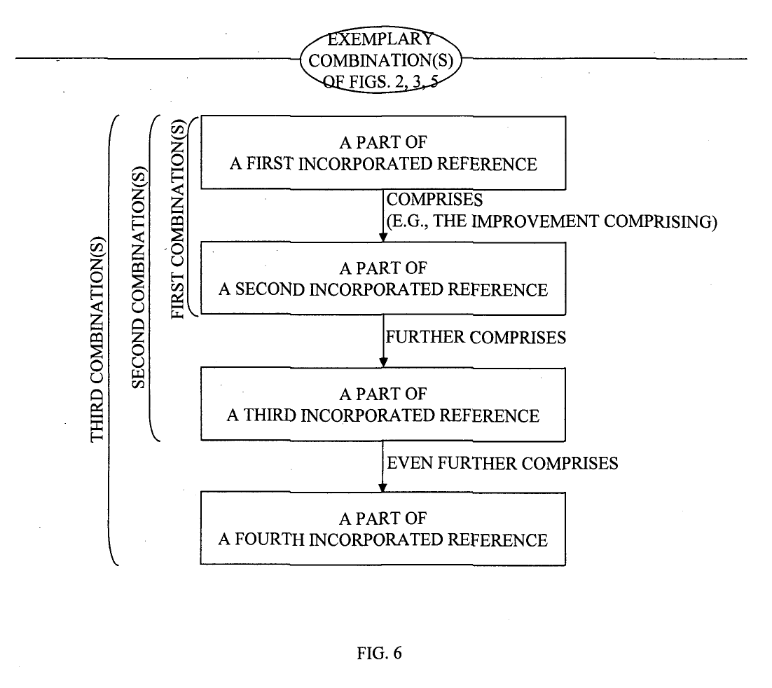

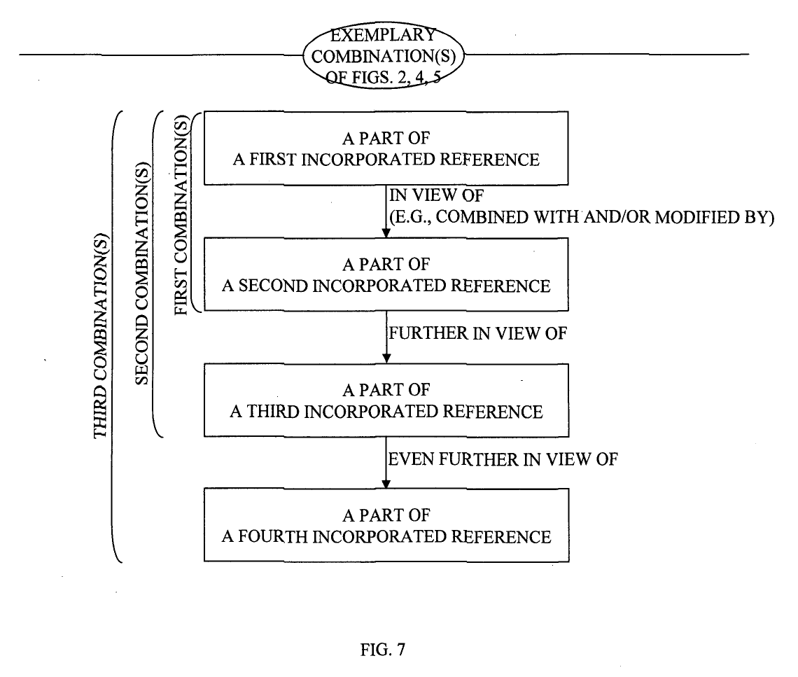

The present patent document, for example, includes a first reference and a second reference (see, for example, FIG. 1). Each of the first reference and the second reference may be a patent document such as, for example, a patent, a patent application, a reference cited in a patent and/or a patent application, etc. The first reference may include at least a first teaching and the second reference may include at least a second teaching. The first teaching may be combined with and/or modified by the second teaching so as to produce an exemplary combination (see, for example, FIGS. 2-7). One combination, for example, may comprise or consist of: the first teaching or a part thereof “in view of” the second teaching or a part thereof, as illustrated by FIG. 7. The exemplary combination, for example, may be used to modify an embodiment or any part thereof from the first reference, in view of an embodiment or any part thereof from the second reference.

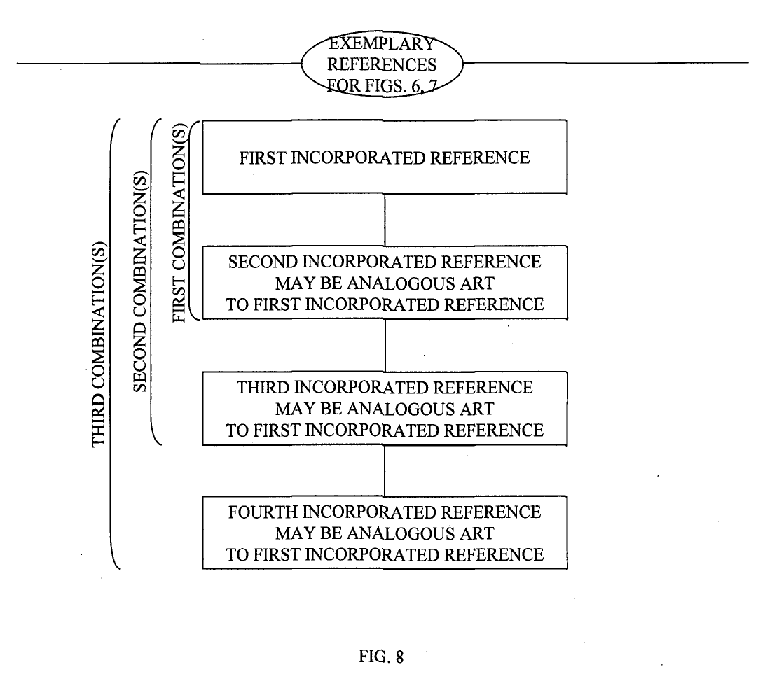

On the one hand, a selection for the second reference may depend upon a selection for the first reference (see, for example, FIGS. 8-31). For example, the second reference may be selected to be (1) a reference cited in the first reference and/or (2) a reference that cites the first reference. On the other hand, each of the first teaching and the second teaching may be selected so as to include subject matter from at least a teaching from a reference. For example, the first teaching is selected to include at least a part of a teaching from the first reference, and the second teaching is selected to include at least a part of a teaching from the second reference.

The second reference may further be selected to be analogous art or nonanalogous art to the first reference. In one exemplary combination, the second reference may be selected to be analogous art to the first reference, and at least one of (1) the first teaching may be selected to be a part of a teaching (rather than a whole teaching) from the first reference and (2) the second teaching may be selected to be a part of a teaching (rather than a whole teaching) from the second reference. In another exemplary combination, the second reference may be selected to be nonanalogous art to the first reference, and at least one of (1) the first teaching may be selected to be a teaching or a part thereof from the first reference and (2) the second teaching may be selected to be a teaching or a part thereof from the second reference.

In short, the present patent document discloses a plurality of combinations that may be relied upon as prior art to render, alone (e.g., 35 U.S.C. §102) or combined with other references (e.g., 35 U.S.C. §103), a plurality of patent claims as unpatentable and/or as invalid (see, for example, FIG. 34). One or more patentable claims may also be presented for examination that is supported by at least an exemplary combination, which may be illustrated by one or more of FIGS. 2-7 (see, for example, FIG. 32).

As of Dec. 11, 2008, a plurality of published patents and a plurality of published patent applications are available electronically from the U.S. Patent & Trademark Office (“the USPTO”) (www.uspto.gov) and the European Patent Office (“the EPO”) (http://ep.espacenet.com/), where all of these published patents and these published patent applications are hereby incorporated by reference in their entireties—illustrated in FIG. 1. The published patents include utility patents, design patents and plant patents, and the published patent applications include utility applications and plant applications. The published patents and the published patent applications include cited references (e.g., citations), all of which are also hereby incorporated by reference in their entireties—also illustrated in FIG. 1. Each of the cited references, for example, may be stated in a references cited section and/or one or more other sections such as, for example, a background section, a description section, etc.

A plurality of teachings and/or parts thereof from one or more incorporated references may be combined, for example, so as to make one or more improvements, substitutions, combinations and/or other modifications (e.g., variation, reconstruction, redesign, etc.) to subject matter incorporated into the present patent document. An exemplary combination may include (1) a first subject matter “in view of” (e.g., combine and/or modify) a second subject matter and/or (2) the first subject matter, the improvement comprising the second subject matter, where subject matter from the incorporated references is applied as the first subject matter and the second subject matter. For example, any subject matter (e.g., any teaching or part thereof, at least a teaching or part thereof, etc.) from the incorporated references may be applied as the first subject matter and any other subject matter (e.g., any other teaching or part thereof, at least a different teaching or part thereof, etc.) from the incorporated references may be applied as the second subject matter. One or more patentable claims may be presented for examination that is supported by at least the exemplary combination, which is illustrated by one or more of FIGS. 2-7.

USPTO databases on the World Wide Web (www.uspto.gov/patft/index.html) include U.S. patents from 1790 to present (e.g., issued by Dec. 11, 2008), all of which have been incorporated by reference in their entireties herein, and published U.S. patent applications from 2001 to present (e.g., published by Dec. 11, 2008), all of which have also been incorporated by reference in their entireties herein. The U.S. patent application database includes (and the present patent document has incorporated by reference) U.S. published patent application nos. 20010000001-20080307552. The U.S. patent database includes (and the present patent document has incorporated by reference) U.S. Pat. Nos.:

| U.S. Patents | Utility | Design | Plant |
|---|---|---|---|
| 1976-present | 3,930,271-7,464,412 | D242,583-D582,625 | PP3,987-PP19,569 |
| 1790-1975 | X1-X11,280; | D1-D242,880 | PP1-P4,000 |
| | 1-3,930,270 | | |

The USPTO has provided a list of patents missing from the patent database (full-text database and full-page image database) and a list of withdrawn patent numbers at http://www.uspto.gov/patft/help/contents.htm.

The USPTO provides a Patent Application Information Retrieval (“PAIR”) system (www.uspto.gov), where information (e.g., information disclosure statement and/or notice of references cited) for published U.S. patent applications may be obtained from a so-called Public PAIR. The USPTO and/or Public PAIR includes published information disclosure statements and published notices of references cited, where all references cited in the published information disclosure statements and the published notices of references cited for the published U.S. patent applications (e.g., U.S. published patent application nos. 20010,000001-20080307552) are hereby incorporated by reference in their entireties.

The EPO's esp@cenet service on the World Wide Web (http://ep.espacenet.com/) includes an EP database, a WIPO database and a worldwide database. All contents (e.g., documents and cited references) included in the esp@cenet databases (the EP database, the WIPO database and the worldwide database)—for example, by Dec. 11, 2008—are hereby incorporated by reference in their entireties. The EP database includes (and the present patent document has incorporated by reference in their entireties herein) patent applications published by the EPO over the last 24 months. The esp@cenet service reports that under normal circumstances new EP documents are added to the EP database on a weekly basis, on the day of publication (Wednesday). The WIPO database includes (and the present patent document has incorporated by reference in their entireties herein) patent applications published by WIPO (WO publications) over the last 24 months. The esp@cenet service reports that under normal circumstances new documents are added to the WIPO database on a weekly basis, two weeks after publication (Wednesday). The worldwide database includes (and the present patent document has incorporated by reference in their entireties herein) EP patents and WO patents older than 24 months, and a plurality of other references such as published patent documents from over 72 countries and regions. The esp@cenet databases (e.g., the worldwide database) also include international search reports, where all references cited in the published international search reports have been incorporated by reference in their entireties herein.

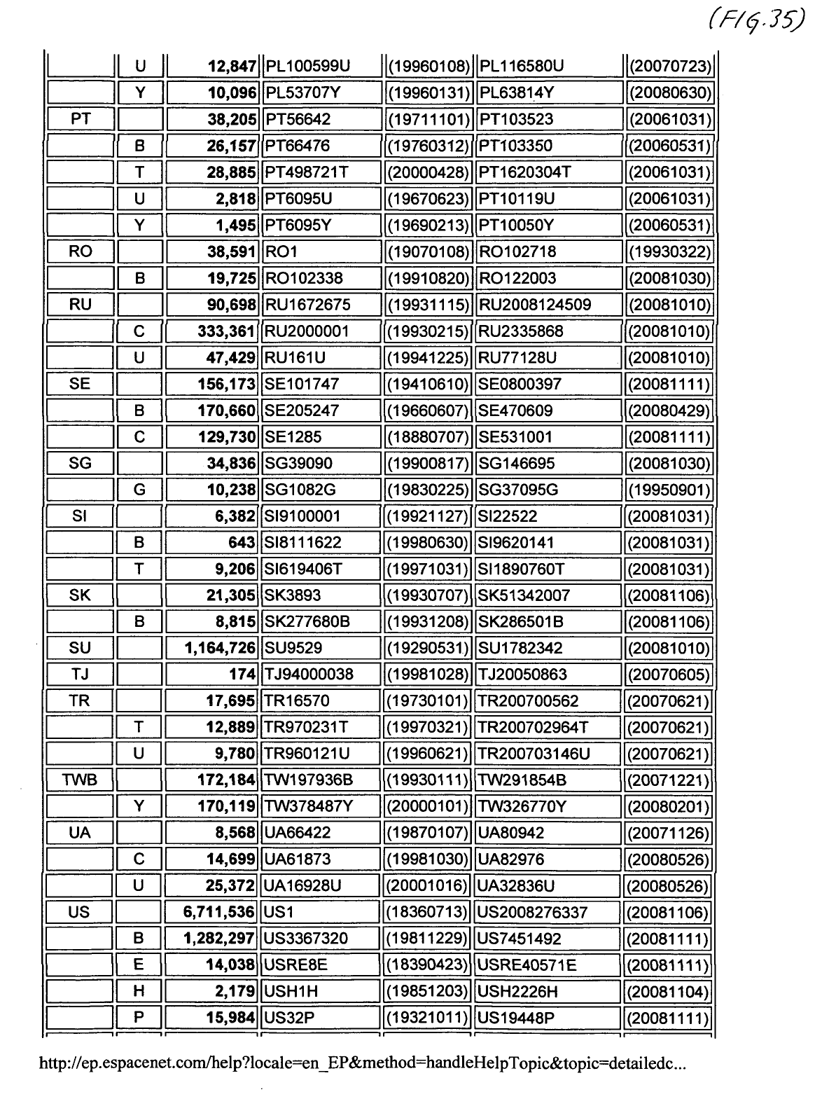

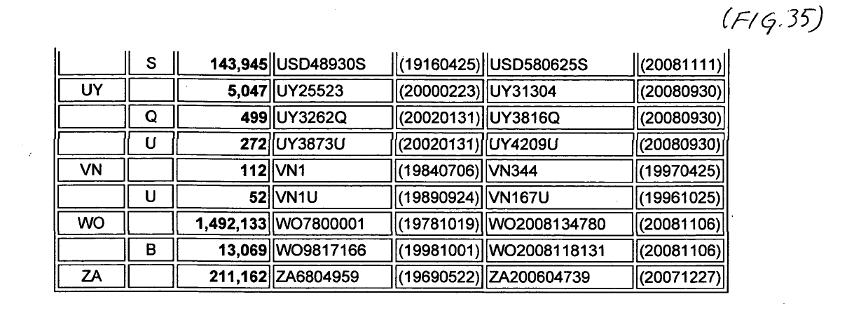

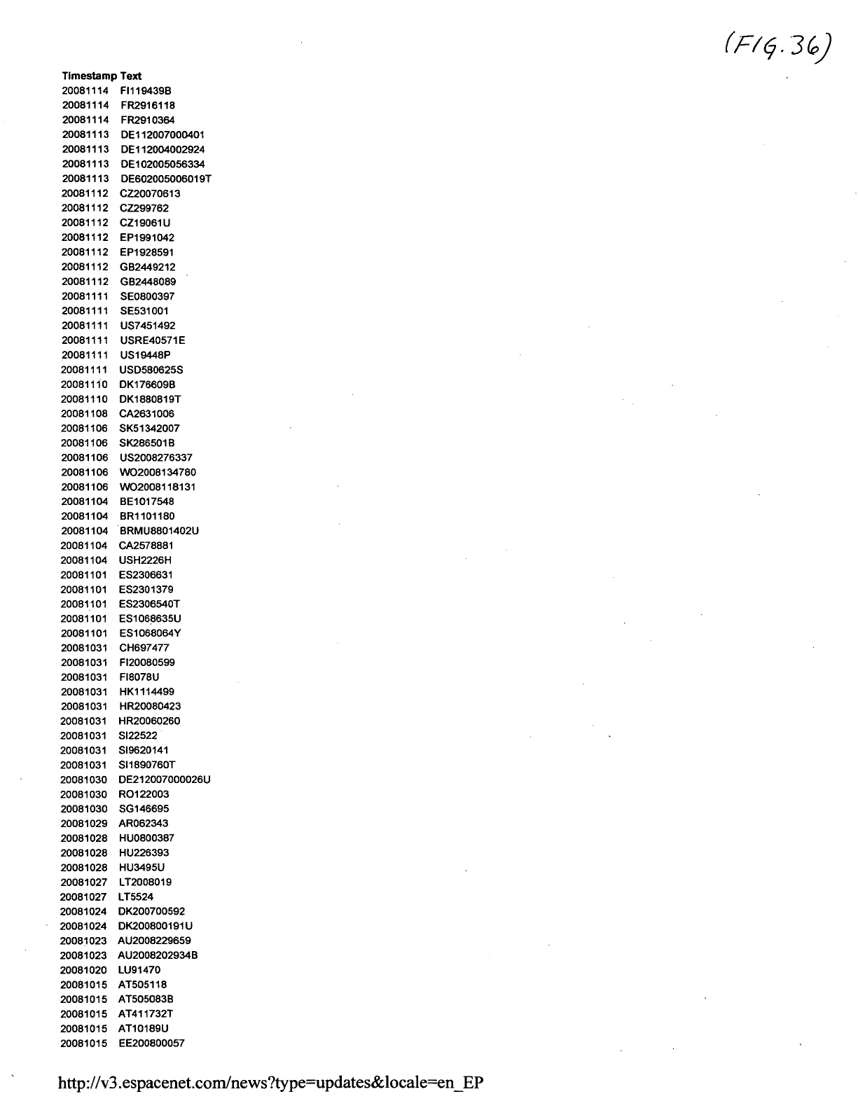

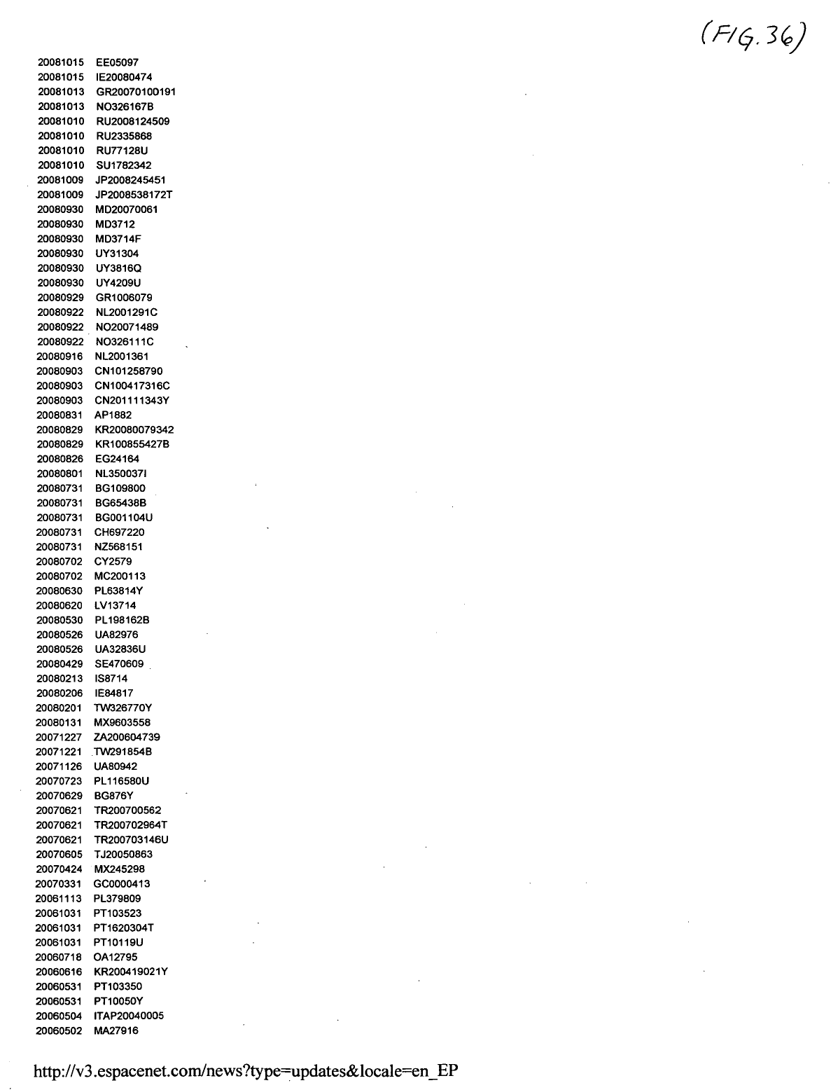

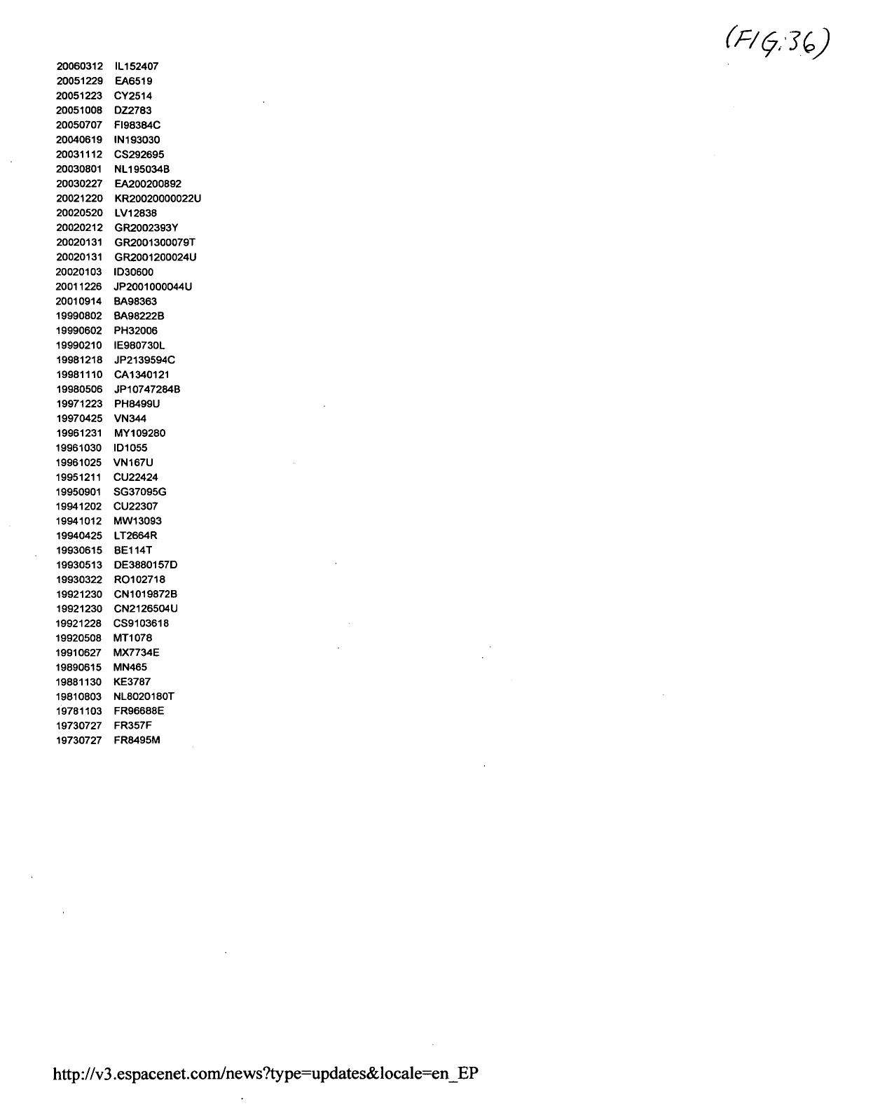

FIG. 35 provides a table, from the esp@cenet service, with an overview of the contents of the worldwide database, where the esp@cenet service reports that the table is current as of Nov. 21, 2008. FIG. 36 provides the “Latest Updates” of the worldwide database, as reported by the esp@cenet service. The contents (e.g., documents and cited references) included in the worldwide database—for example, by Dec. 11, 2008—have been incorporated by reference in their entireties herein.

The present patent document includes a specification, which has incorporated by reference in their entireties all published patents and all published patent applications, for example, that are available electronically from the USPTO and the EPO by Dec. 11, 2008, which is a filing date of the present patent document. The specification has also incorporated by reference in their entireties all references (e.g., documents) cited in the incorporated patents, the incorporated patent applications and others such as published information disclosure statements and published notices of references cited, and published international search reports, for example, that are available electronically from the USPTO and the EPO, respectively, by Dec. 11, 2008. Thus, the incorporated references include the incorporated patents, the incorporated patent applications and/or the other incorporated references, for example, that may be available electronically from the USPTO and/or the EPO.

Another exemplary combination may include (1) a part from a primary reference in view of at least a part from a secondary reference and/or (2) the part from the primary reference, the improvement comprising the part from the secondary reference, where anyone of the incorporated references may be applied as the primary reference and any different one of the incorporated references may be applied as the secondary reference. The part from the primary reference may include a teaching or a part thereof, and the part from the secondary reference may include a different teaching or a part thereof, where any subject matter of the primary reference may be applied as the part from the primary reference and any subject matter of the secondary reference may be applied as the part from the secondary reference. One or more patentable claims may be presented for examination that is supported by at least the exemplary combination, which is illustrated by one or more of FIGS. 2-7.

A selection for the secondary reference may depend upon a selection for the primary reference. Each of the incorporated references, for example, may be applied (e.g., one at a time) as the primary reference. Any different one of the incorporated references may then be applied as the secondary reference.

For example, the secondary reference may be any nonanalogous art (e.g., a nonanalogous incorporated reference) to the primary reference. The secondary reference may also be any analogous art (e.g., an analogous incorporated reference) to the primary reference. The secondary reference may not cite and/or may not be cited in the primary reference. The secondary reference, also, may cite and/or may be cited in the primary reference. The secondary reference may not include an assignee and/or an applicant that may be named in the primary reference. For example, the secondary reference may be assigned to a competitor of an assignee of the primary reference. The secondary reference may also include an assignee and/or an applicant that may be named in the primary reference. Each of the primary reference and the secondary reference, for an exemplary combination(s), may be one of (1) a utility patent document, (2) a design patent document, (3) a plant patent document and (4) other document. For example, the secondary reference may be one of (1) an incorporated utility patent document, (2) an incorporated design patent document and (3) an incorporated plant patent document, and the primary reference may be one of (1) a different incorporated utility patent document, (2) a different incorporated design patent document and (3) a different incorporated plant patent document.

Each of the incorporated references may be considered as a plurality of parts, where each of the parts, in whole or in part, may be combined with one or more other parts, for example, from the same incorporated reference and/or one or more other incorporated references, so as to produce one or more combinations (see, for example, FIGS. 2-7). The parts may be combined, for example, to improve, modify, change, adapt, substitute and/or other (e.g., expand, narrow, replace, relocate, exclude, add, omit, etc.), in part or in whole, one or more of the parts. For example, a combination may modify a configuration, a characteristic, a result, a function, a property, a goal, an effect, a linkage, an end-product, a structure, a use and/or other of an embodiment and/or a part(s) thereof from one or more of the incorporated references.

Each of the parts to be combined, for example, may include subject matter from one or more teachings and/or any other disclosure from an incorporated reference. The other disclosure, for example, may include a suggestion, a motivation, a description, an illustration, a problem to solve, a solution, an object, an embodiment, a feature and/or other. Each of the parts to be combined, for example, may not include some subject matter from each of the incorporated references that includes (e.g., teaches) one of the parts. The some subject matter, for example, may include a portion arguing against and/or teaching away from a combination(s) (e.g., a combination of the parts) and/or a description that criticizes, discredits and/or otherwise discourages the combination(s). Each of the parts may be selected, in part or in whole, from an abstract section, a background section, a summary section, a drawings section, a detailed description section, a claims section and/or other section(s) of an incorporated reference. Each of the parts, for example, may include one or more teachings and/or any other disclosure from a preferred, non-preferred, encouraged, discouraged and/or other combination(s) and/or part(s) thereof of an incorporated reference.

The number of parts and/or incorporated references to be combined (e.g., for each of the combinations) may be any number such as, for example, a smaller number (e.g., 2, 3, etc.) and/or a larger number (e.g., 10, 11, etc.). The length of time between the publication dates (e.g., issue dates of patents) of the incorporated references with the part(s) relied upon for a combination(s) may be any time such as, for example, a shorter time (e.g., 0.5, 1, 2, etc. years) and/or a larger time (e.g., 25, 75, 125, etc. years). Each of the exemplary combinations (e.g., illustrated in FIGS. 2-7) may be directed to an apparatus, a method, a composition and/or other, for example, as identified in any of the claim preambles of the incorporated patents/patent applications.

One or more patentable claims may be presented for examination that is supported by one or more combinations of teachings and/or others (e.g., features) from the incorporated references and/or parts thereof. The one or more combinations may include a first combination of parts (e.g., teachings) from a single incorporated reference and/or a second combination of parts (e.g., teachings) from a plurality of incorporated references.

FIG. 3 illustrates a first subject matter, the improvement comprising a second subject matter as a first combination. FIG. 3 also illustrates the first combination, the improvement further comprising a third subject matter as a second combination. FIG. 3 further illustrates the second combination, the improvement even further comprising a fourth subject matter as a third combination, where any subject matter from the incorporated references may be applied as the first subject matter, the second subject matter, the third subject matter and the fourth subject matter—illustrated in FIG. 3. Each of the first combination, the second combination and the third combination illustrated in FIG. 3 may be open-ended (e.g., comprises a plurality of parts) and/or closed-ended (e.g., consists of a plurality of parts).

FIG. 4 illustrates a first combination that includes a first subject matter in view of a second subject matter. FIG. 4 also illustrates a second combination that includes the first subject matter in view of the second subject matter, and further in view of a third subject matter. FIG. 4 further illustrates a third combination that includes the first subject matter in view of the second subject matter, and further in view of the third subject matter, and even further in view of a fourth subject matter. Any subject matter from the incorporated references may also be applied as the first subject matter, the second subject matter, the third subject matter and the fourth subject matter—illustrated in FIG. 4.

FIG. 5 illustrates a plurality of exemplary combinations such as, for example, a plurality of exemplary combinations as illustrated by FIGS. 3, 4, 6 and/or 7, and/or a plurality of other exemplary combinations. An exemplary combination(s) may include at least one of (1) a first subject matter, (2) a second subject matter, (3) a third subject matter, (4) a fourth subject matter, (5) the first subject matter in view of at least one of the second subject matter, the third subject matter and the fourth subject matter, (6) the second subject matter in view of at least one of the first subject matter, the third subject matter and the fourth subject matter, (7) the third subject matter in view of at least one of the first subject matter, the second subject matter and the fourth subject matter and (8) the fourth subject matter in view of at least one of the first subject matter, the second subject matter and the third subject matter. The exemplary combination(s) may also exclude at least a different one. Any subject matter from the incorporated references may again be applied as the first subject matter, the second subject matter, the third subject matter and the fourth subject matter—illustrated in FIG. 5.

For example, any subject matter (e.g., any teaching or part thereof) from the group of the incorporated references may be applied as the first subject matter of one or more of FIGS. 3-5, any other subject matter (e.g., any other teaching or part thereof) from the group of the incorporated references may be applied as the second subject matter of one or more of FIGS. 3-5, any other different subject matter (e.g., any other different teaching or part thereof) from the group of the incorporated references may further be applied as the third subject matter of one or more of FIGS. 3-5, and any other different subject matter (e.g., any other different teaching or part thereof) from the group of the incorporated references may even further be applied as the fourth subject matter of one or more of FIGS. 3-5. One or more patentable claims may be presented for examination that is supported by at least one or more of the exemplary combinations of FIGS. 3-5.

FIG. 6 illustrates a part of a first incorporated reference, the improvement comprising a part of a second incorporated reference as a first combination. FIG. 6 also illustrates the first combination, the improvement further comprising a part of a third incorporated reference as a second combination. FIG. 6 further illustrates the second combination, the improvement even further comprising a part of a fourth incorporated reference as a third combination, where any subject matter from the incorporated references may be applied as the part of the first incorporated reference, the part of the second incorporated reference, the part of the third incorporated reference and the part of the fourth incorporated reference—illustrated in FIG. 6. Each of the first combination, the second combination and the third combination illustrated in FIG. 6 may be open-ended (e.g., comprises a plurality of parts) and/or closed-ended (e.g., consists of a plurality of parts).

FIG. 7 illustrates a first combination that includes a part of a first incorporated reference in view of a part of a second incorporated reference. FIG. 7 also illustrates a second combination that includes the part of the first incorporated reference in view of the part of the second incorporated reference, and further in view of a part of a third incorporated reference. FIG. 7 further illustrates a third combination that includes the part of the first incorporated reference in view of the part of the second incorporated reference, and further in view of the part of the third incorporated reference, and even further in view of a part of a fourth incorporated reference. Any subject matter from the incorporated references may also be applied as the part of the first incorporated reference, the part of the second incorporated reference, the part of the third incorporated reference and the part of the fourth incorporated reference—illustrated in FIG. 7.

For example, anyone of the incorporated references may be applied as the first incorporated reference of one or more of FIGS. 6-7, any other one of the incorporated references may be applied as the second incorporated reference of one or more of FIGS. 6-7, any other different one of the incorporated references may further be applied as the third incorporated reference of one or more of FIGS. 6-7, and any other different one of the incorporated references may even further be applied as the fourth incorporated reference of one or more of FIGS. 6-7.

The part from the first incorporated reference may include a teaching or a part thereof, the part from the second incorporated reference may include a different teaching or a part thereof, the part from the third incorporated reference may also include a different teaching or a part thereof, and the part from the fourth incorporated reference may further include a different teaching or a part thereof. Any subject matter (e.g., at least a teaching or part thereof) of the first incorporated reference may be applied as the part from the first incorporated reference of one or more of FIGS. 6-7, any subject matter (e.g., at least a teaching or part thereof) of the second incorporated reference may be applied as the part from the second incorporated reference of one or more of FIGS. 6-7, any subject matter (e.g., at least a teaching or part thereof) of the third incorporated reference may be applied as the part from the third incorporated reference of one or more of FIGS. 6-7, and any subject matter (e.g., at least a teaching or part thereof) of the fourth incorporated reference may be applied as the part from the fourth incorporated reference of one or more of FIGS. 6-7. One or more patentable claims may be presented for examination that is supported by at least the exemplary combination, which is illustrated by one or more of FIGS. 6-7.

Each of the first incorporated reference, the second incorporated reference, the third incorporated reference and/or the fourth incorporated reference depicted in FIGS. 6 and 7, for example, may be any of the incorporated references. FIGS. 8-31 provide a plurality of exemplary combinations of references that may be applied for the first incorporated reference, the second incorporated reference, the third incorporated reference and/or the fourth incorporated reference depicted in FIGS. 6 and/or 7. Each of the first incorporated reference, the second incorporated reference, the third incorporated reference and the fourth incorporated reference may be a different incorporated reference.

A selection for each of the second incorporated reference, the third incorporated reference and the fourth incorporated reference may depend upon a selection for the first incorporated reference, where each of the incorporated references, for example, may be applied (e.g., one at a time) as the first incorporated reference—see, for example, FIGS. 6-31. Any different one of the incorporated references may then be applied as the second incorporated reference, any other different one of the incorporated references may further be applied as the third incorporated reference and any other different one of the incorporated references may even further be applied as the fourth incorporated reference.

FIG. 8 depicts that the first incorporated reference may be any of the incorporated references, and each of the second incorporated reference, the third incorporated reference and the fourth incorporated reference may be any of the incorporated references considered as analogous art to the first incorporated reference. Each of the incorporated references, for example, may be applied (e.g., one at a time) as the first incorporated reference that is depicted by FIG. 8.

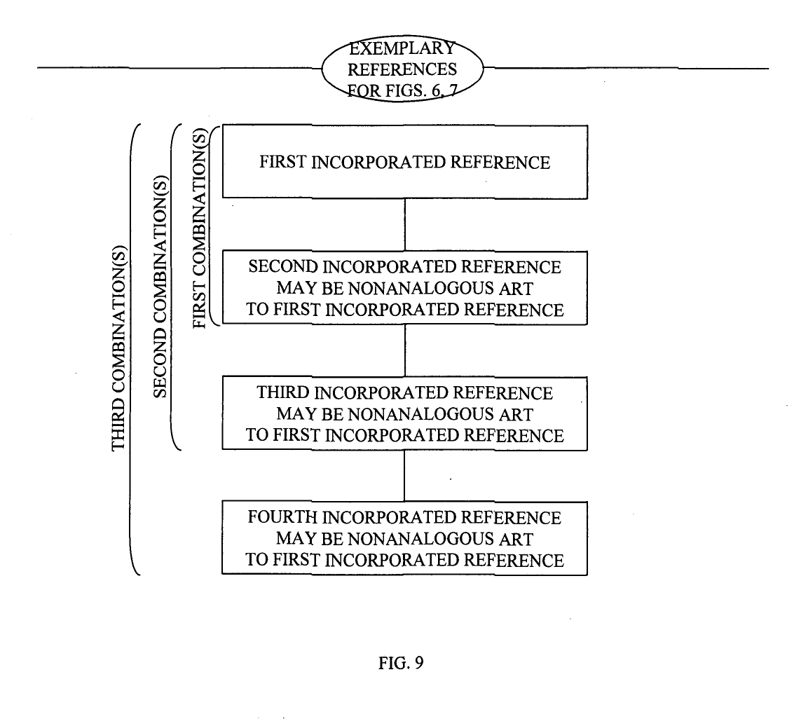

FIG. 9 depicts that the first incorporated reference may be any of the incorporated references, and each of the second incorporated reference, the third incorporated reference and the fourth incorporated reference may be any of the incorporated references considered as nonanalogous art to the first incorporated reference. Each of the incorporated references, for example, may be applied (e.g., one at a time) as the first incorporated reference that is depicted by FIG. 9.

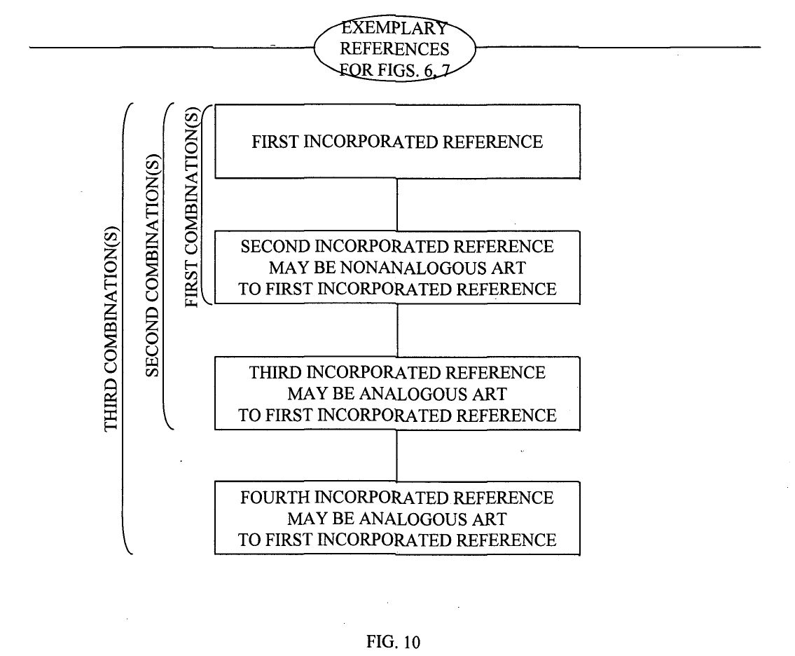

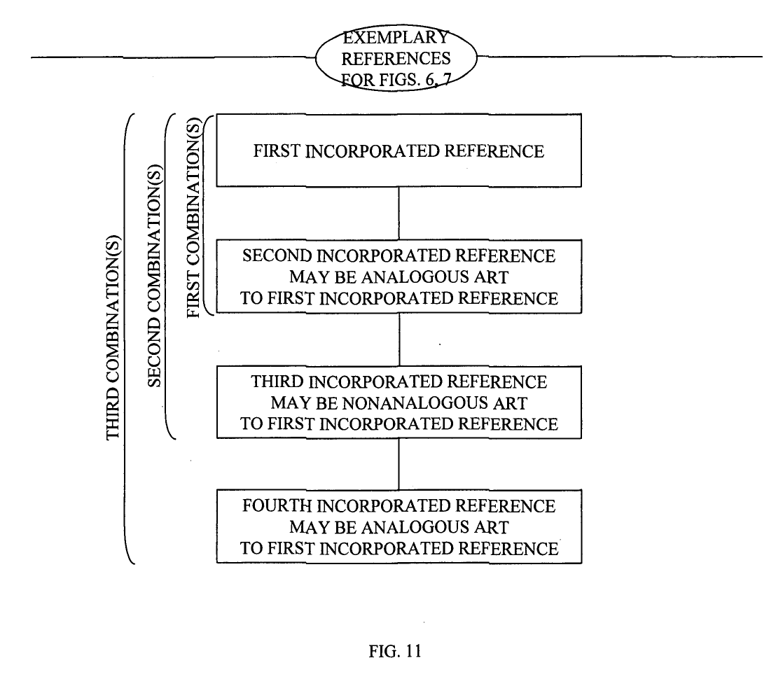

FIG. 10 depicts that the first incorporated reference may be any of the incorporated references, the second incorporated reference may be any of the incorporated references considered as nonanalogous art to the first incorporated reference, and each of the third incorporated reference and the fourth incorporated reference may be any of the incorporated references considered as analogous art to the first incorporated reference. Each of the incorporated references, for example, may be applied (e.g., one at a time) as the first incorporated reference that is depicted by FIG. 10.

FIG. 11 depicts that the first incorporated reference may be any of the incorporated references, the third incorporated reference may be any of the incorporated references considered as nonanalogous art to the first incorporated reference, and each of the second incorporated reference and the fourth incorporated reference may be any of the incorporated references considered as analogous art to the first incorporated reference. Each of the incorporated references, for example, may be applied (e.g., one at a time) as the first incorporated reference that is depicted by FIG. 11.

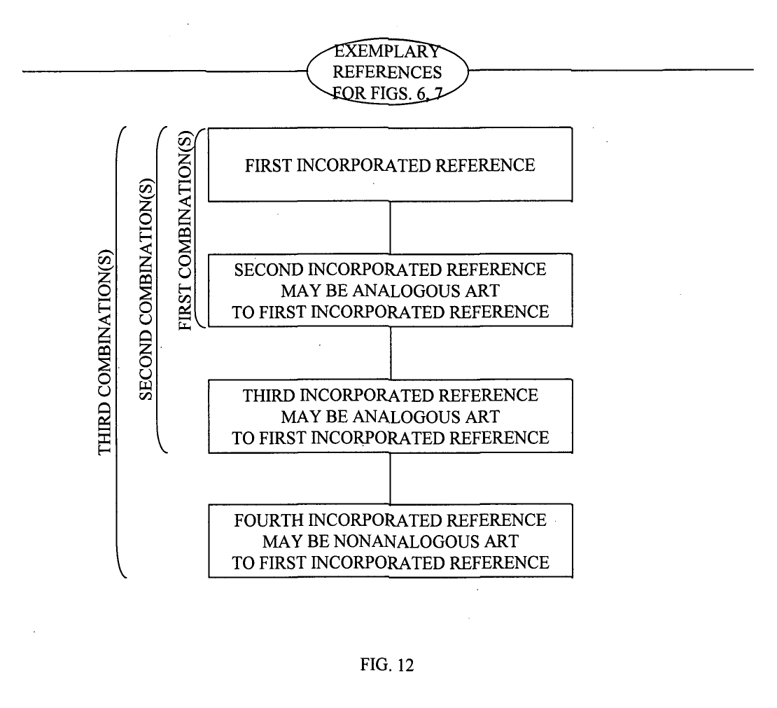

FIG. 12 depicts that the first incorporated reference may be any of the incorporated references, the fourth incorporated reference may be any of the incorporated references considered as nonanalogous art to the first incorporated reference, and each of the second incorporated reference and the third incorporated reference may be any of the incorporated references considered as analogous art to the first incorporated reference. Each of the incorporated references, for example, may be applied (e.g., one at a time) as the first incorporated reference that is depicted by FIG. 12.

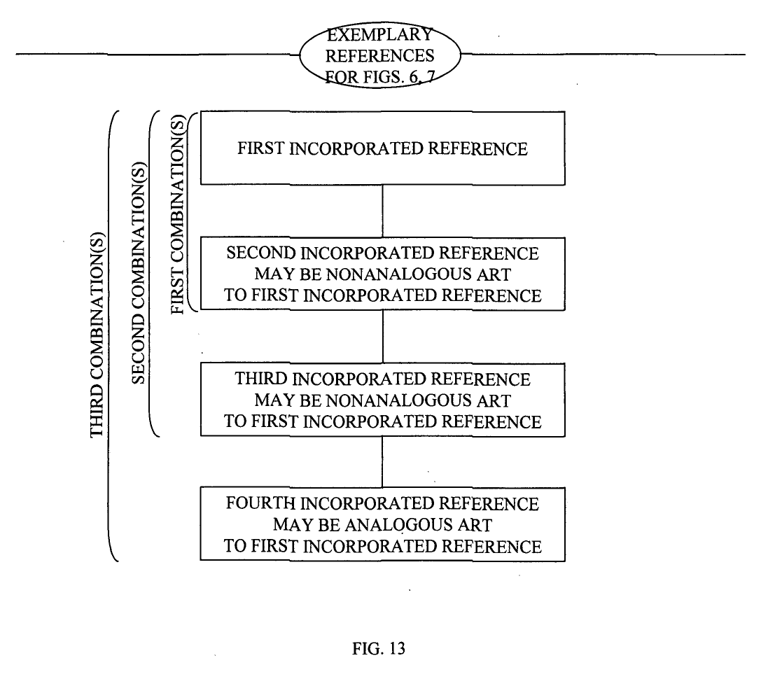

FIG. 13 depicts that the first incorporated reference may be any of the incorporated references, each of the second incorporated reference and the third incorporated reference may be any of the incorporated references considered as nonanalogous art to the first incorporated reference, and the fourth incorporated reference may be any of the incorporated references considered as analogous art to the first incorporated reference. Each of the incorporated references, for example, may be applied (e.g., one at a time) as the first incorporated reference that is depicted by FIG. 13.

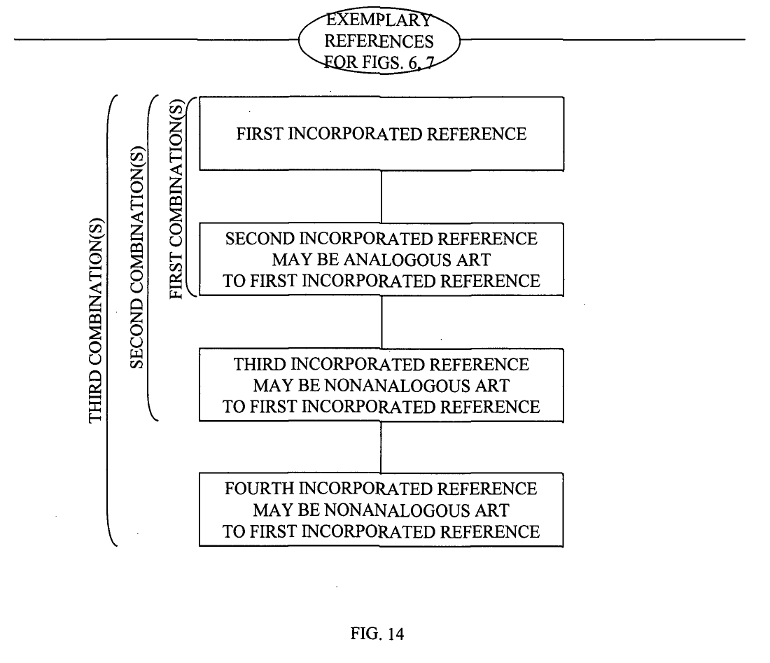

FIG. 14 depicts that the first incorporated reference may be any of the incorporated references, each of the third incorporated reference and the fourth incorporated reference may be any of the incorporated references considered as nonanalogous art to the first incorporated reference, and the second incorporated reference may be any of the incorporated references considered as analogous art to the first incorporated reference. Each of the incorporated references, for example, may be applied (e.g., one at a time) as the first incorporated reference that is depicted by FIG. 14.

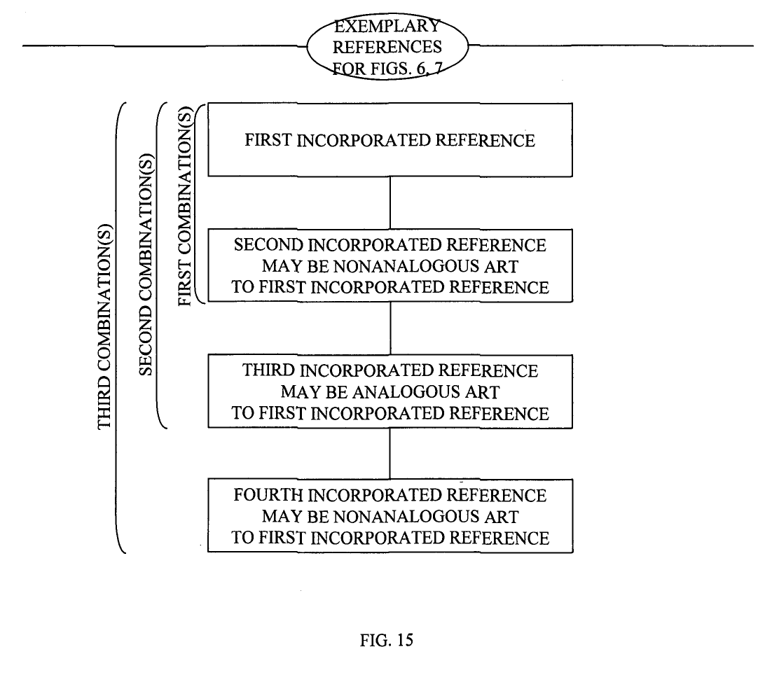

FIG. 15 depicts that the first incorporated reference may be any of the incorporated references, each of the second incorporated reference and the fourth incorporated reference may be any of the incorporated references considered as nonanalogous art to the first incorporated reference, and the third incorporated reference may be any of the incorporated references considered as analogous art to the first incorporated reference. Each of the incorporated references, for example, may be applied (e.g., one at a time) as the first incorporated reference that is depicted by FIG. 15.

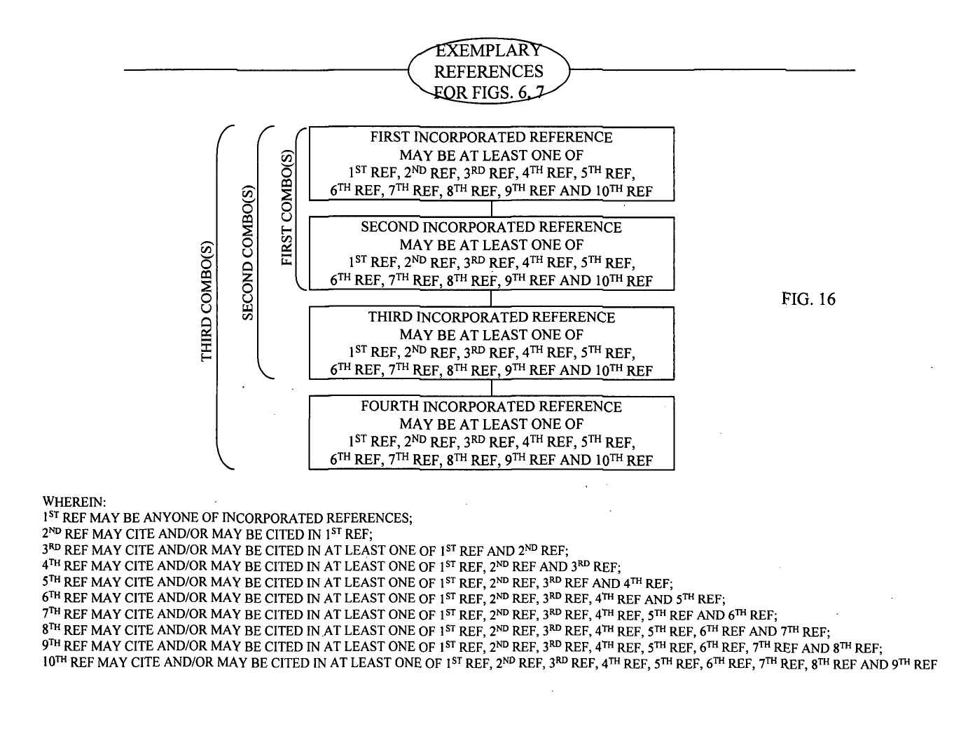

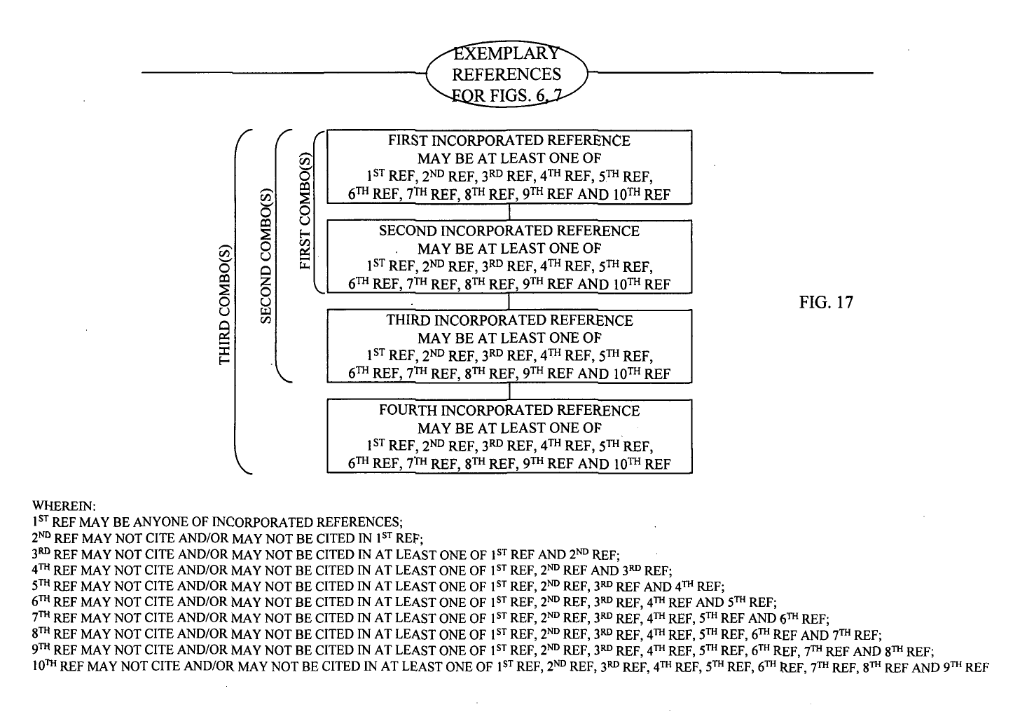

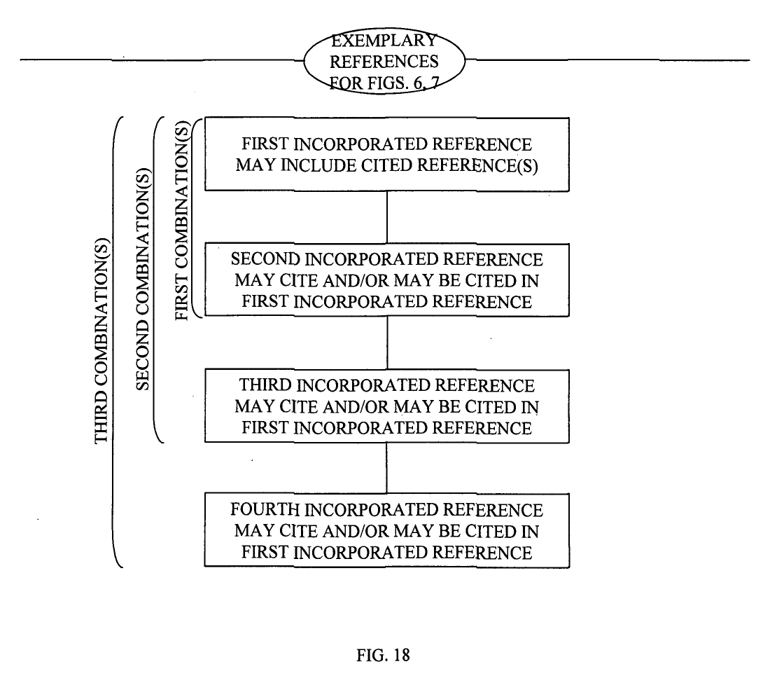

Each of FIGS. 16 and 17 depicts that each of the first incorporated reference, the second incorporated reference, the third incorporated reference and the fourth incorporated reference may be at least one of a 1^{st} reference, a 2^{nd} reference, a 3^{rd} reference, a 4^{th} reference, a 5^{th} reference, a 6^{th} reference, a 7^{th} reference, a 8^{th} reference, a 9^{th} reference and a 10^{th} reference.

FIG. 16 depicts that the 1^{st} reference may be any of the incorporated references; the 2^{nd} reference may be any of the incorporated references citing and/or cited in the 1^{st} reference; the 3^{rd} reference may be any of the incorporated references citing and/or cited in at least one of the 1^{st} reference and the 2^{nd} reference; the 4^{th} reference may be any of the incorporated references citing and/or cited in at least one of the 1^{st} reference, the 2^{nd} reference and the 3^{rd} reference; the 5^{th} reference may be any of the incorporated references citing and/or cited in at least one of the 1^{st} reference, the 2^{nd} reference, the 3^{rd} reference and the 4^{th} reference; the 6^{th} reference may be any of the incorporated references citing and/or cited in at least one of the 1^{st} reference, the 2^{nd} reference, the 3^{rd} reference, the 4^{th} reference and the 5^{th} reference; the 7^{th} reference may be any of the incorporated references citing and/or cited in at least one of the 1^{st} reference, the 2^{nd} reference, the 3^{rd} reference, the 4^{th} reference, the 5^{th} reference and the 6^{th} reference; the 8^{th} reference may be any of the incorporated references citing and/or cited in at least one of the 1^{st} reference, the 2^{nd} reference, the 3^{rd} reference, the 4^{th} reference, the 5^{th} reference, the 6^{th} reference and the 7^{th} reference; the 9^{th} reference may be any of the incorporated references citing and/or cited in at least one of the 1^{st} reference, the 2^{nd} reference, the 3^{rd} reference, the 4^{th} reference, the 5^{th} reference, the 6^{th} reference, the 7^{th} reference and the 8^{th} reference; and the 10^{th} reference may be any of the incorporated references citing and/or cited in at least one of the 1^{st} reference, the 2^{nd} reference, the 3^{rd} reference, the 4^{th} reference, the 5^{th} reference, the 6^{th} reference, the 7^{th} reference, the 8^{th} reference and the 9^{th} reference. Each of the incorporated references, for example, may be applied (e.g., one at a time) as the 1^{st} reference that is depicted by FIG. 16.

FIG. 17, on the other hand, depicts that the 1^{st} reference may be any of the incorporated references; the 2^{nd} reference may be any of the incorporated references not citing and/or not cited in the 1^{st} reference; the 3^{rd} reference may be any of the incorporated references not citing and/or not cited in at least one of the 1^{st} reference and the 2^{nd} reference; the 4^{th} reference may be any of the incorporated references not citing and/or not cited in at least one of the 1^{st} reference, the 2^{nd} reference and the 3^{rd} reference; the 5^{th} reference may be any of the incorporated references not citing and/or not cited in at least one of the 1^{st} reference, the 2^{nd} reference, the 3^{rd} reference and the 4^{th} reference; the 6^{th} reference may be any of the incorporated references not citing and/or not cited in at least one of the 1^{st} reference, the 2^{nd} reference, the 3^{rd} reference, the 4^{th} reference and the 5^{th} reference; the 7^{th} reference may be any of the incorporated references not citing and/or not cited in at least one of the 1^{st} reference, the 2^{nd} reference, the 3^{rd} reference, the 4^{th} reference, the 5^{th} reference and the 6^{th} reference; the 8^{th} reference may be any of the incorporated references not citing and/or not cited in at least one of the 1^{st} reference, the 2^{nd} reference, the 3^{rd} reference, the 4^{th} reference, the 5^{th} reference, the 6^{th} reference and the 7^{th} reference; the 9^{th} reference may be any of the incorporated references not citing and/or not cited in at least one of the 1^{st} reference, the 2^{nd} reference, the 3^{rd} reference, the 4^{th} reference, the 5^{th} reference, the 6^{th} reference, the 7^{th} reference and the 8^{th} reference; and the 10^{th} reference may be any of the incorporated references not citing and/or not cited in at least one of the 1^{st} reference, the 2^{nd} reference, the 3^{rd} reference, the 4^{th} reference, the 5^{th} reference, the 6^{th} reference, the 7^{th} reference, the 8^{th} reference and the 9^{th} reference. Each of the incorporated references, for example, may be applied (e.g., one at a time) as the 1^{st} reference that is depicted by FIG. 17.

FIG. 18 depicts that the first incorporated reference may be any of the incorporated references, and each of the second incorporated reference, the third incorporated reference and the fourth incorporated reference may be any of the incorporated references citing and/or cited in the first incorporated reference. Each of the incorporated references, for example, may be applied (e.g., one at a time) as the first incorporated reference that is depicted by FIG. 18.

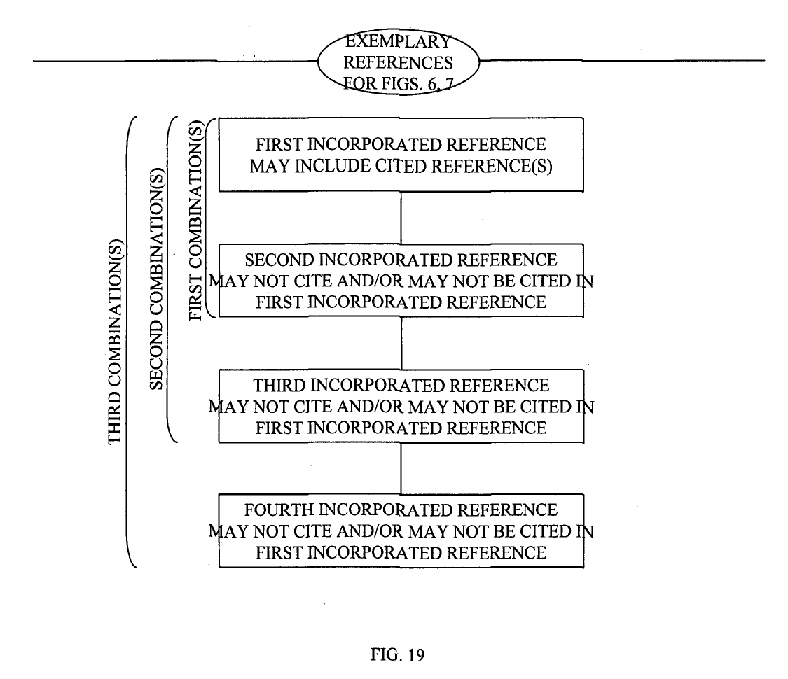

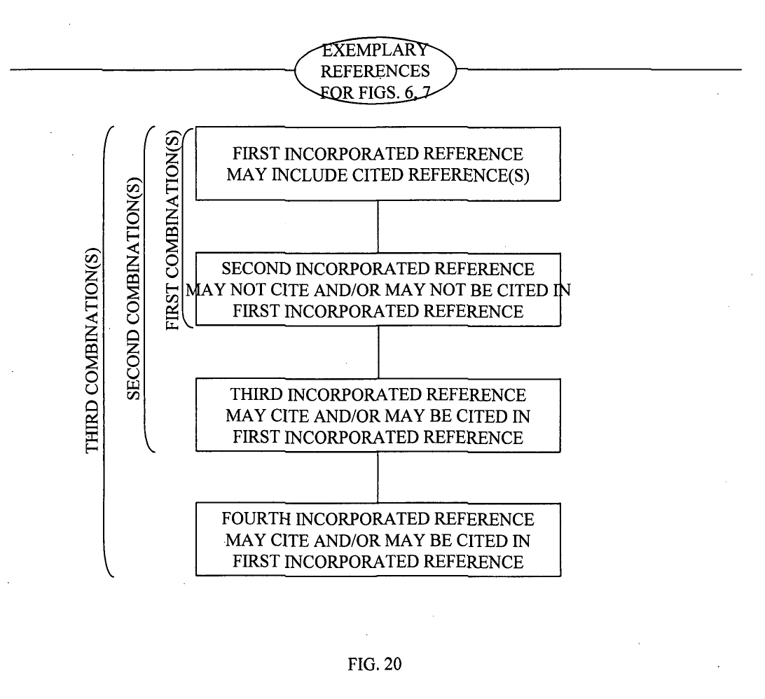

FIG. 19 depicts that the first incorporated reference may be any of the incorporated references, and each of the second incorporated reference, the third incorporated reference and the fourth incorporated reference may be any of the incorporated references not citing and/or not cited in the first incorporated reference. Each of the incorporated references, for example, may be applied (e.g., one at a time) as the first incorporated reference that is depicted by FIG. 19.

FIG. 20 depicts that the first incorporated reference may be any of the incorporated references, the second incorporated reference may be any of the incorporated references not citing and/or not cited in the first incorporated reference, and each of the third incorporated reference and the fourth incorporated reference may be any of the incorporated references citing and/or cited in the first incorporated reference. Each of the incorporated references, for example, may be applied (e.g., one at a time) as the first incorporated reference that is depicted by FIG. 20.

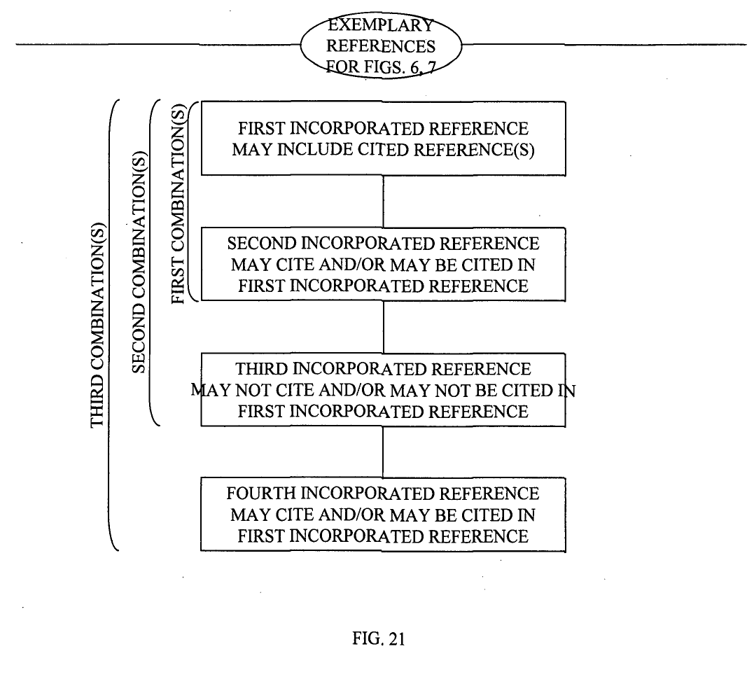

FIG. 21 depicts that the first incorporated reference may be any of the incorporated references, the third incorporated reference may be any of the incorporated references not citing and/or not cited in the first incorporated reference, and each of the second incorporated reference and the fourth incorporated reference may be any of the incorporated references citing and/or cited in the first incorporated reference. Each of the incorporated references, for example, may be applied (e.g., one at a time) as the first incorporated reference that is depicted by FIG. 21.

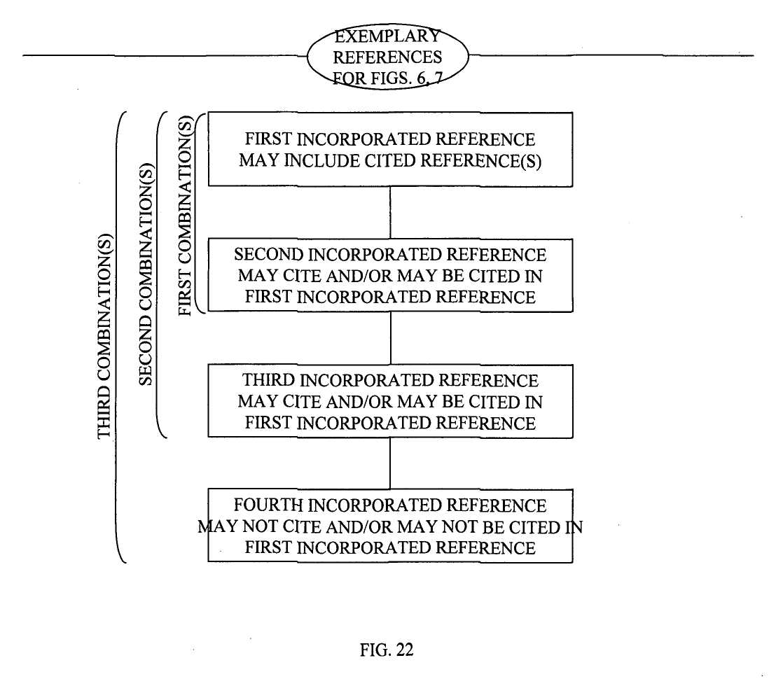

FIG. 22 depicts that the first incorporated reference may be any of the incorporated references, the fourth incorporated reference may be any of the incorporated references not citing and/or not cited in the first incorporated reference, and each of the second incorporated reference and the third incorporated reference may be any of the incorporated references citing and/or cited in the first incorporated reference. Each of the incorporated references, for example, may be applied (e.g., one at a time) as the first incorporated reference that is depicted by FIG. 22.

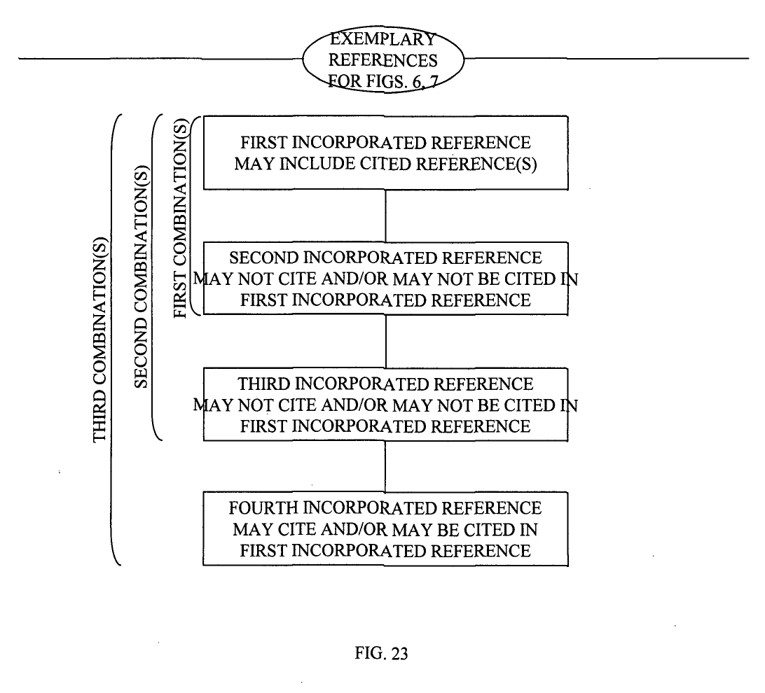

FIG. 23 depicts that the first incorporated reference may be any of the incorporated references, each of the second incorporated reference and the third incorporated reference may be any of the incorporated references not citing and/or not cited in the first incorporated reference, and the fourth incorporated reference may be any of the incorporated references citing and/or cited in the first incorporated reference. Each of the incorporated references, for example, may be applied (e.g., one at a time) as the first incorporated reference that is depicted by FIG. 23.

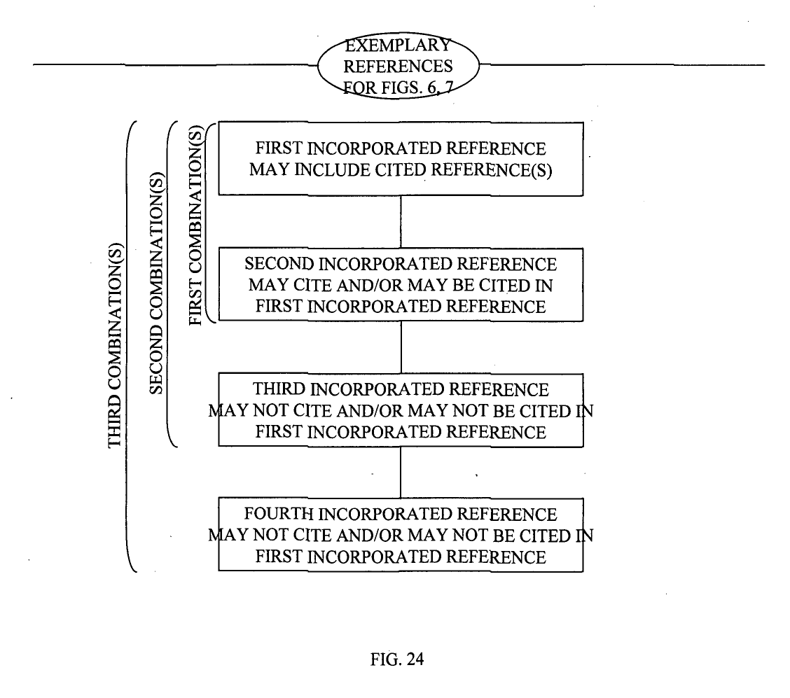

FIG. 24 depicts that the first incorporated reference may be any of the incorporated references, each of the third incorporated reference and the fourth incorporated reference may be any of the incorporated references not citing and/or not cited in the first incorporated reference, and the second incorporated reference may be any of the incorporated references citing and/or cited in the first incorporated reference. Each of the incorporated references, for example, may be applied (e.g., one at a time) as the first incorporated reference that is depicted by FIG. 24.

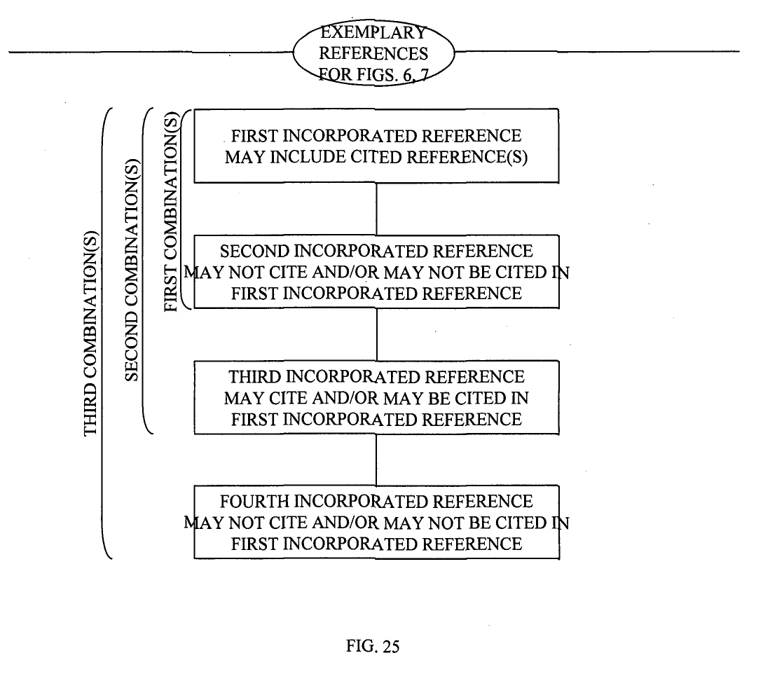

FIG. 25 depicts that the first incorporated reference may be any of the incorporated references, each of the second incorporated reference and the fourth incorporated reference may be any of the incorporated references not citing and/or not cited in the first incorporated reference, and the third incorporated reference may be any of the incorporated references citing and/or cited in the first incorporated reference. Each of the incorporated references, for example, may be applied (e.g., one at a time) as the first incorporated reference that is depicted by FIG. 25.

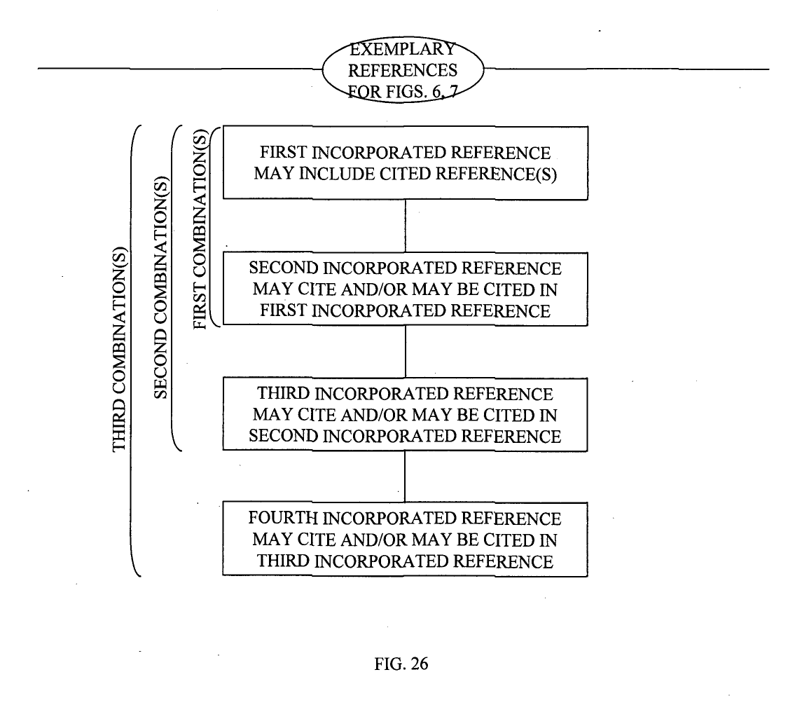

FIG. 26 depicts that the first incorporated reference may be any of the incorporated references, the second incorporated reference may be any of the incorporated references citing and/or cited in the first incorporated reference, the third incorporated reference may be any of the incorporated references citing and/or cited in the second incorporated reference and the fourth incorporated reference may be any of the incorporated references citing and/or cited in the third incorporated reference. Each of the incorporated references, for example, may be applied (e.g., one at a time) as the first incorporated reference that is depicted by FIG. 26.

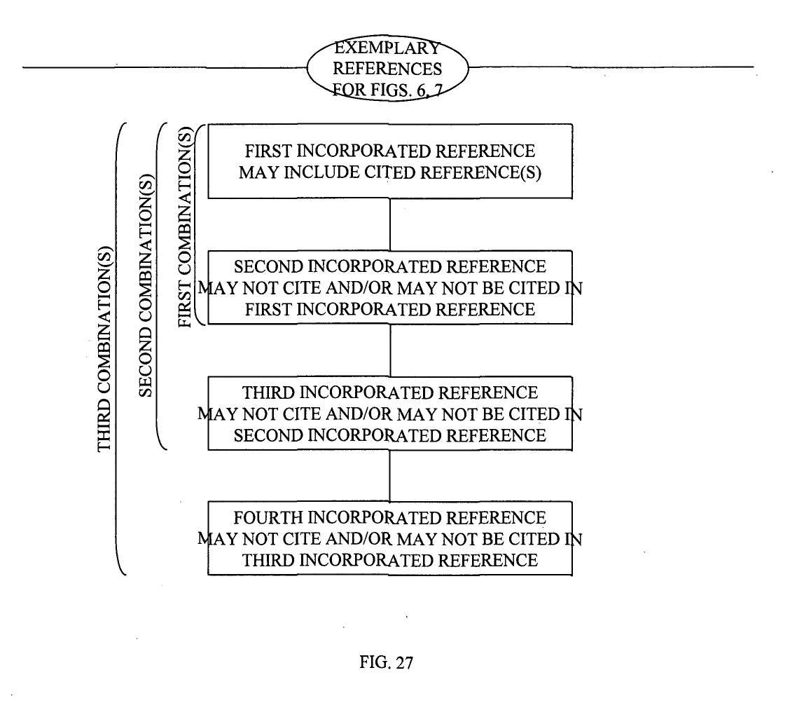

FIG. 27 depicts that the first incorporated reference may be any of the incorporated references, the second incorporated reference may be any of the incorporated references not citing and/or not cited in the first incorporated reference, the third incorporated reference may be any of the incorporated references not citing and/or not cited in the second incorporated reference and the fourth incorporated reference may be any of the incorporated references not citing and/or not cited in the third incorporated reference. Each of the incorporated references, for example, may be applied (e.g., one at a time) as the first incorporated reference that is depicted by FIG. 27.

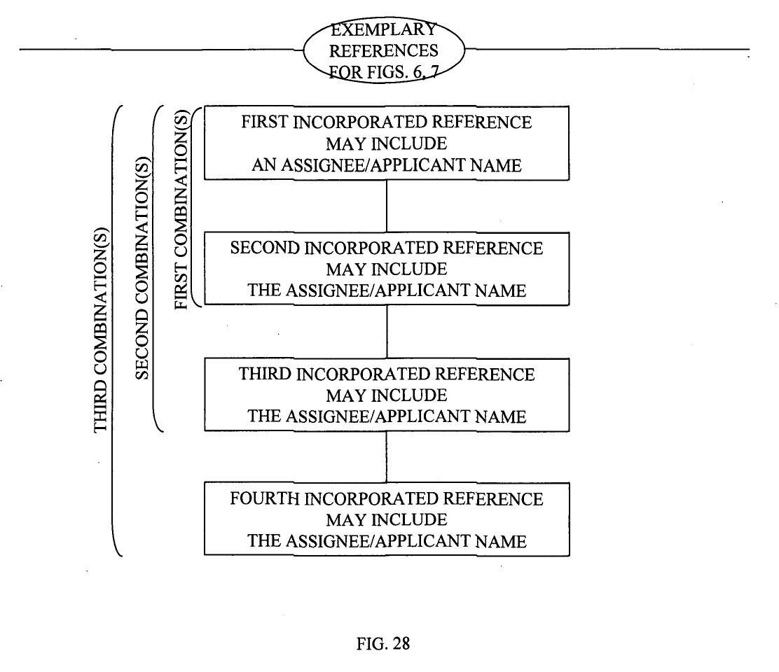

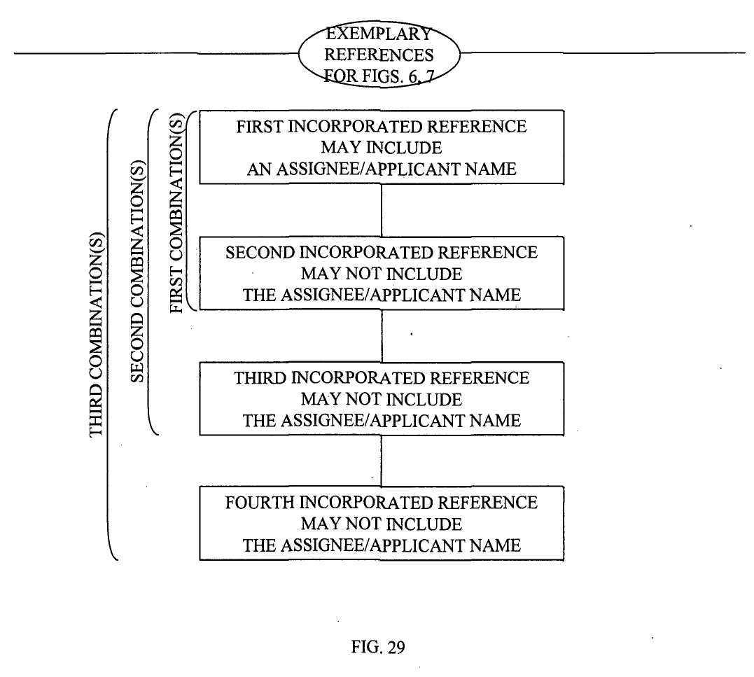

FIG. 28 depicts that the first incorporated reference may be any of the incorporated references, and each of the second incorporated reference, the third incorporated reference and the fourth incorporated reference may be any of the incorporated references with an assignee and/or an applicant named in the first incorporated reference. Each of the incorporated references, for example, may be applied (e.g., one at a time) as the first incorporated reference that is depicted by FIG. 28.

FIG. 29 depicts that the first incorporated reference may be any of the incorporated references, and each of the second incorporated reference, the third incorporated reference and the fourth incorporated reference may be any of the incorporated references with an assignee and/or an applicant not named in the first incorporated reference. Each of the incorporated references, for example, may be applied (e.g., one at a time) as the first incorporated reference that is depicted by FIG. 29.

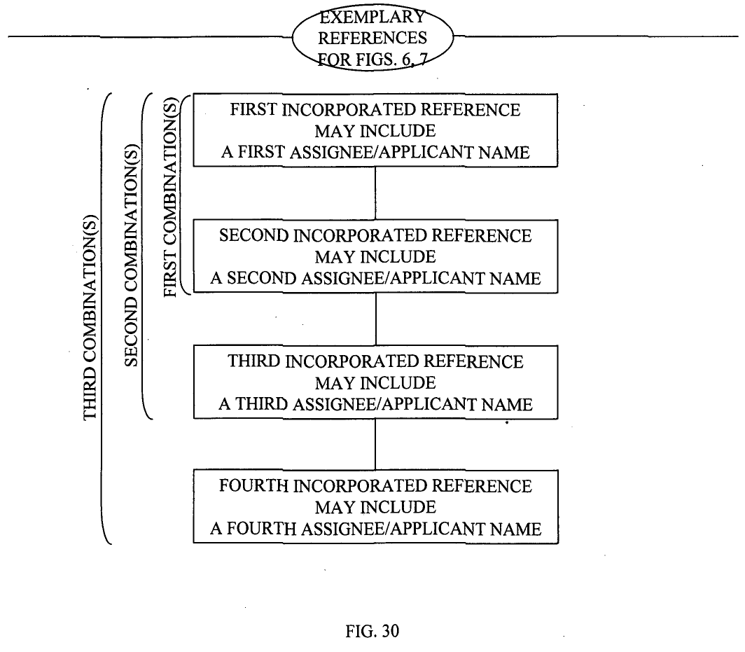

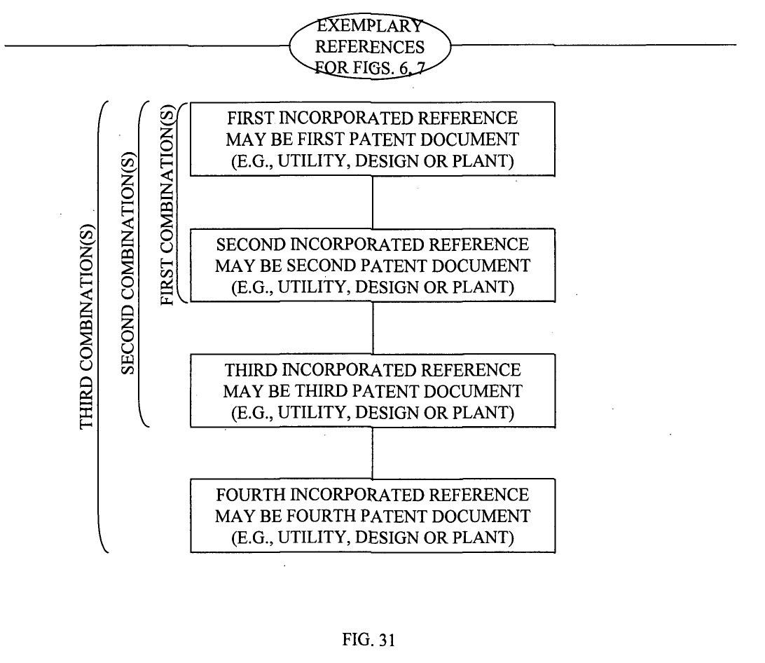

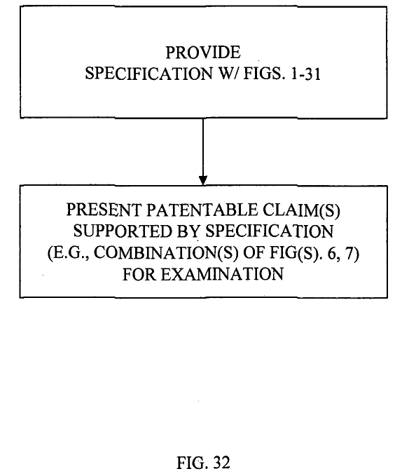

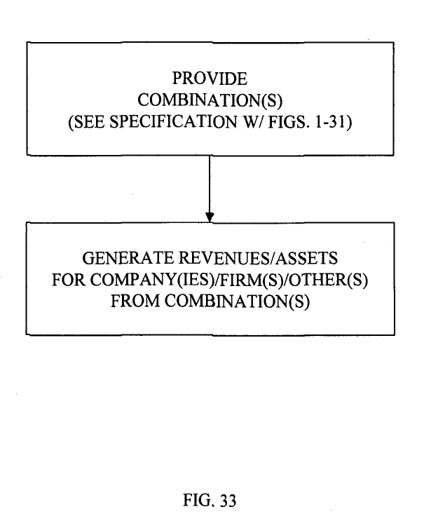

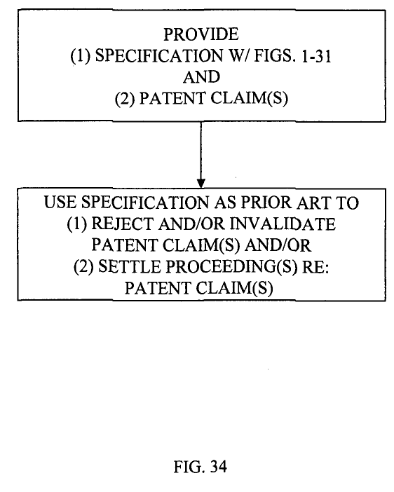

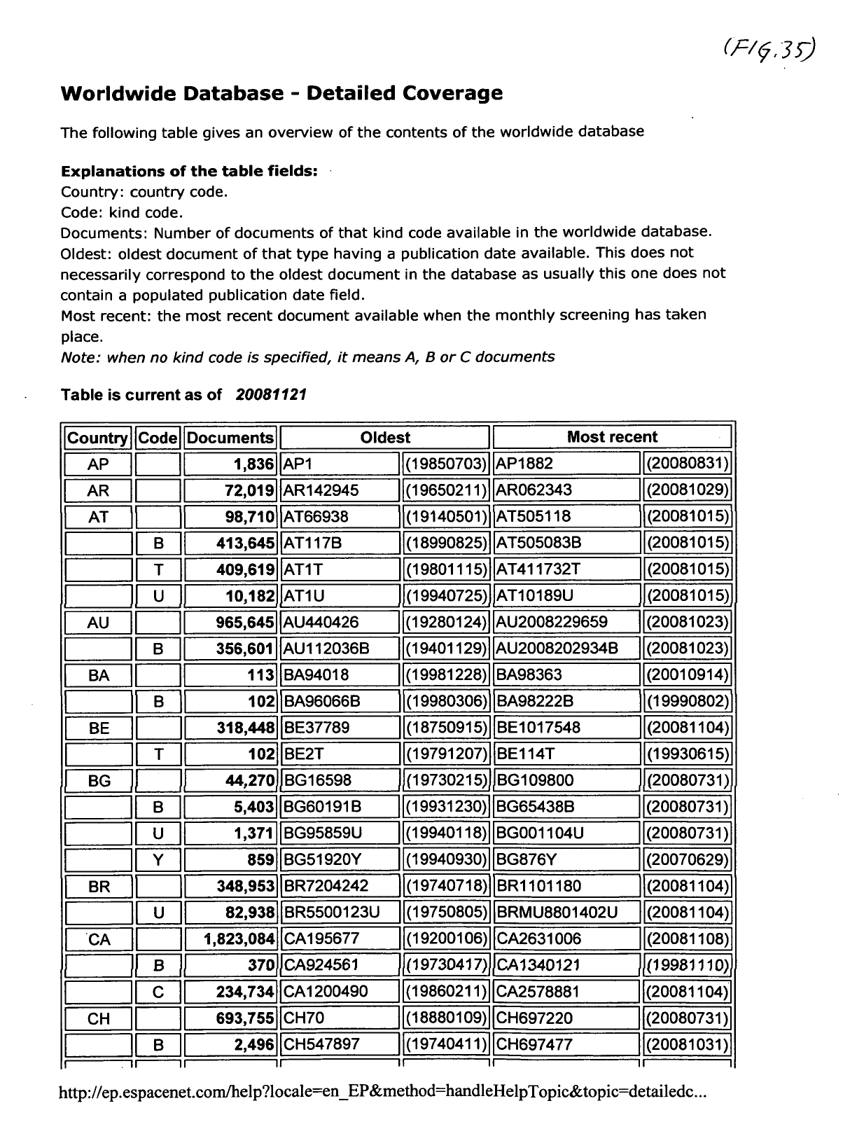

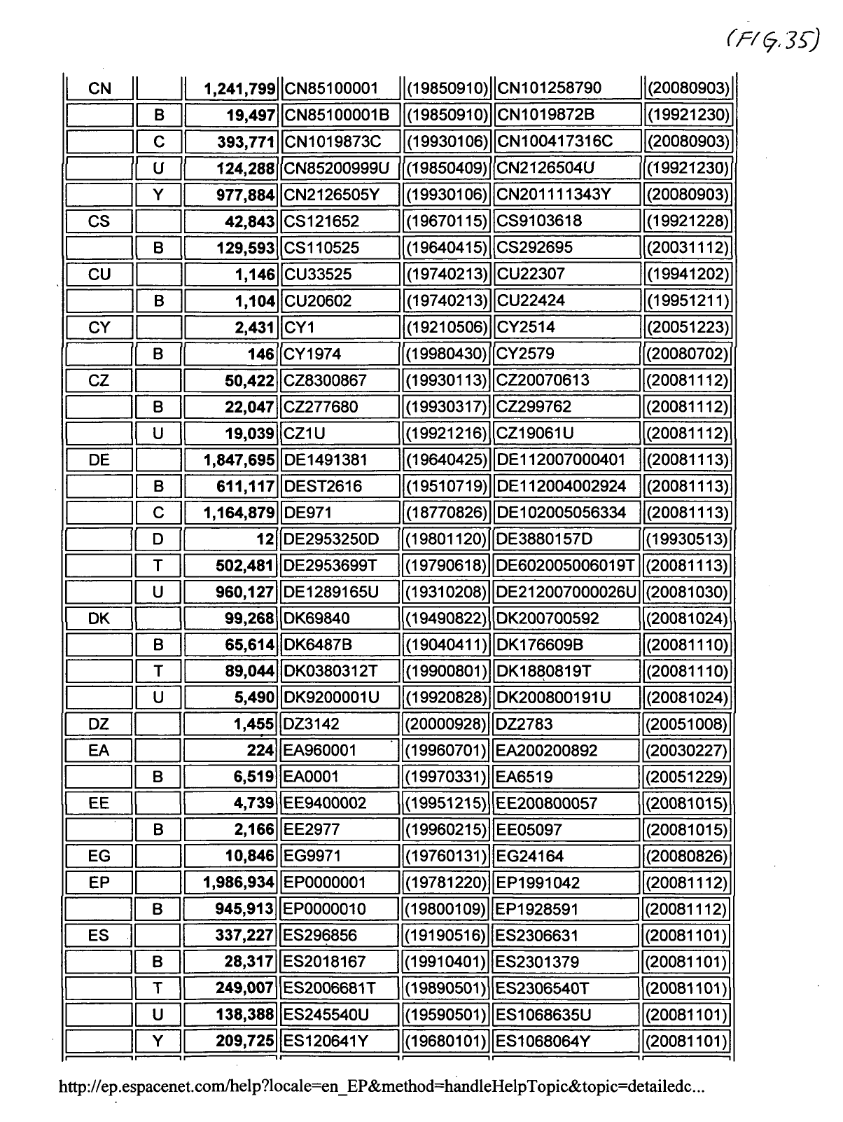

FIG. 30 depicts that the first incorporated reference may be any of the incorporated references, the second incorporated reference may be any of the incorporated references with a different assignee and/or applicant than the first incorporated reference, the third incorporated reference may be any of the incorporated references with a different assignee and/or applicant than the second incorporated reference, and the fourth incorporated reference may be any of the incorporated references with a different assignee and/or applicant than the third incorporated reference. A first assignee and/or applicant of the first incorporated reference, a second assignee and/or applicant of the second incorporated reference, a third assignee and/or applicant of the third incorporated reference and/or a fourth assignee and/or applicant of the fourth incorporated reference, for example, may be, in part or in whole, past and/or present partners, competitors and/or other. Each of the incorporated references, for example, may be applied (e.g., one at a time) as the first incorporated reference that is depicted by FIG. 30.

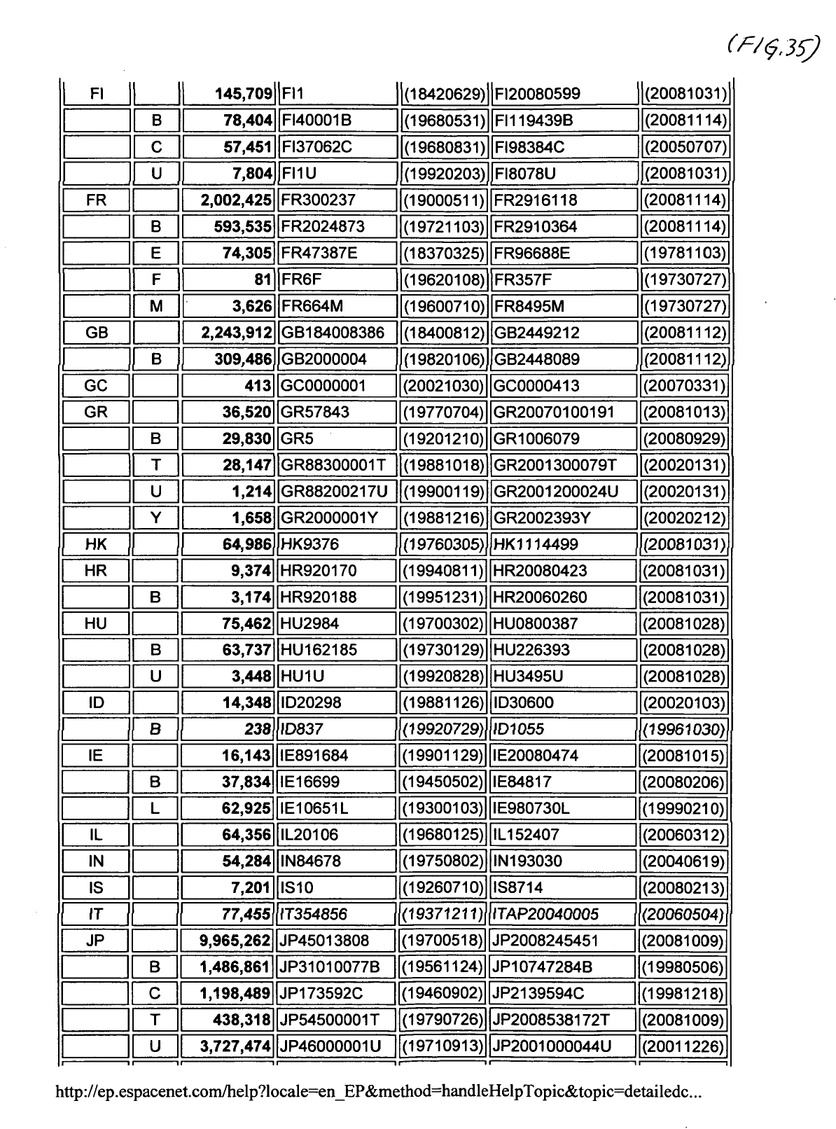

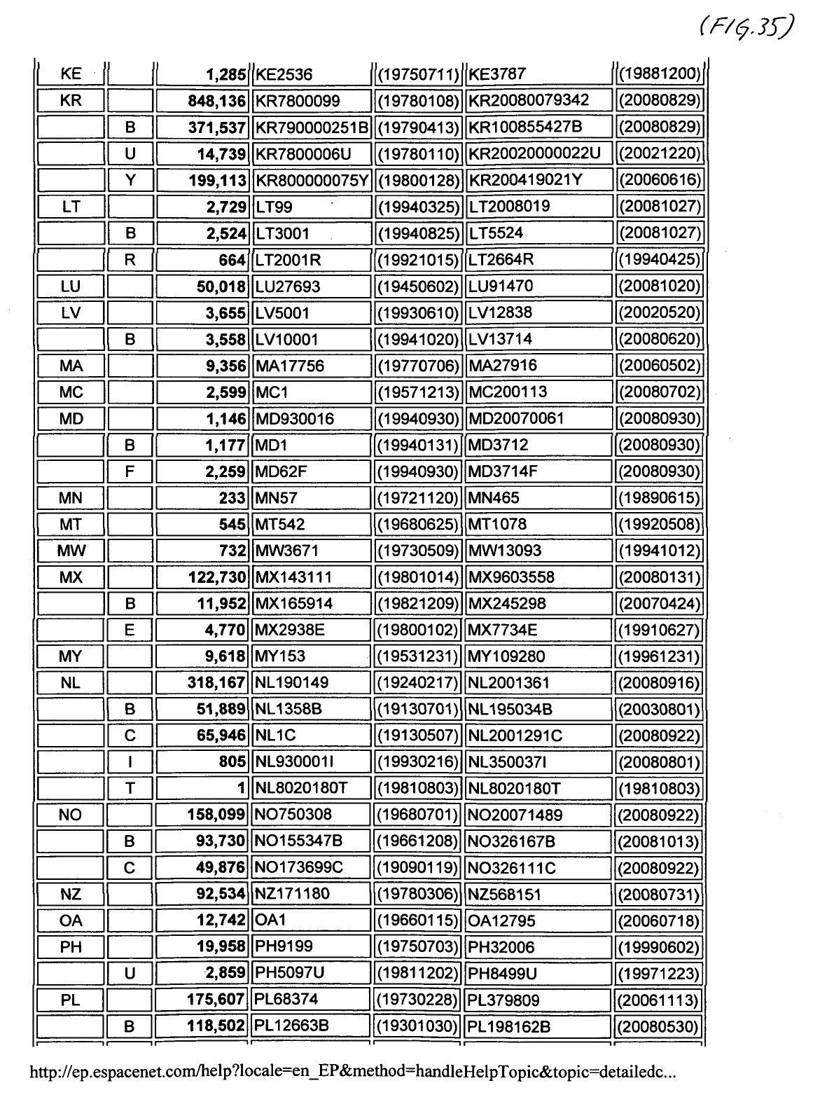

FIG. 31 depicts that each of the first incorporated reference, the second incorporated reference, the third incorporated reference and the fourth incorporated reference may be any of the incorporated references, which include patents, patent applications and other references (e.g., references cited in the patents, the patent applications, the information disclosure statements, the notices of references cited and/or the international search reports). For example, each of the first incorporated reference, the second incorporated reference, the third incorporated reference and the fourth incorporated reference, for an exemplary combination(s), may be one of (1) a utility patent document, (2) a design patent document and (3) a plant patent document.

FIGS. 8-15, for example, depict each of the second incorporated reference, the third incorporated reference and the fourth incorporated reference as analogous art and/or nonanalogous art to the first incorporated reference. FIGS. 16-27, for example, depict each of the second incorporated reference, the third incorporated reference and the fourth incorporated reference as citing and/or not citing, and/or cited and/or not cited in one or more incorporated references (e.g., the first incorporated reference and/or other(s)). A reference(s), for example, (1) cited in an incorporated reference and/or (2) cited in an information disclosure statement, a notice of references cited and/or an international search report for the incorporated reference is cited in the incorporated reference. FIGS. 28-30, for example, depict each of the second incorporated reference, the third incorporated reference and the fourth incorporated reference as with and/or without an assignee and/or an applicant named in the first incorporated reference. FIG. 31, for example, depicts each of the first incorporated reference, the second incorporated reference, the third incorporated reference and the fourth incorporated reference as a patent document such as, for example, a utility patent document, a design patent document, a plant patent document and/or other document. Any of the incorporated references, for example, may be applied as the first incorporated reference, the second incorporated reference, the third incorporated reference and the fourth incorporated reference that are depicted by each of FIGS. 8-31.

Each of the parts from the incorporated references depicted by each of FIGS. 6 and 7, for example, may be any of (e.g., at least one of) the teachings (e.g., any part of a teaching) and/or other disclosure from one or more sections (e.g., abstract, drawings, description, and/or claims) of any of the incorporated references, for example, as described above. For example, each of the incorporated references includes a plurality of parts (e.g., a teaching(s) and/or a part thereof, a feature(s) and/or a part thereof, an embodiment(s) and/or a part thereof, etc.), where one or more of the parts (e.g., a first teaching(s), for example, from a first embodiment or a part thereof), in whole or in part, may be combined with and/or modified by one or more other parts (e.g., a second teaching(s), for example, from a second embodiment or a part thereof), for example, from the same patent document and/or other patent document(s) so as to produce one or more combinations.

A plurality of teachings and/or parts thereof from one or more incorporated references, for example, may be combined so as to make improvements, substitutions, combinations and/or other modifications to incorporated subject matter (see, for example, FIGS. 1-30). The plurality of teachings and/or parts thereof, for example, may not include some subject matter from the one or more incorporated references such as, for example, (1) a portion teaching away from the combination, (2) a teaching (e.g., as a reference may include a plurality of teachings, where the combination may include just a single teaching from the reference), (3) a part of a teaching (e.g., as a teaching may include a plurality of parts, where the combination may include just a single part from the teaching), (4) a section (e.g., as a reference may include a plurality of sections, where the combination may include subject matter from just a single section) and/or (5) other subject matter (e.g., one or more objects).

In sum, a combination may include (1) a first subject matter in view of a second subject matter and/or (2) the first subject matter, the improvement comprising the second subject matter. The combination may be open-ended (e.g., comprising) and/or closed-ended (e.g., consisting of). The combination may also be directed to an apparatus, a method, a composition and/or other. Any disclosure (e.g., any teaching or part thereof, at least a teaching or part thereof, etc.) from the group of the incorporated patents, the incorporated patent applications and/or the other incorporated references may be applied as the first subject matter, and any other disclosure (e.g., any other teaching or part thereof, at least a different teaching or part thereof, etc.) from the group of the incorporated patents, the incorporated patent applications and/or the other incorporated references may be applied as the second subject matter—depicted in FIGS. 1-5. FIGS. 6 and 7, with and/or without FIGS. 8-15, FIGS. 16-27, FIGS. 28-30 and/or FIG. 31, depict examples of the combination, where one or more patentable claims may be presented for examination that is supported by at least one or more of the examples—depicted in FIG. 32.

### Revenues and Assets

FIG. 33 illustrates a method that provides a combination(s), for example, as depicted by one or more of FIGS. 2-31 and/or as described above. The method may generate and/or recognize revenues and/or assets (e.g., tangible and/or intangible asset(s)) for at least a company(ies), firm(s), individual(s) and/or other(s) (e.g., a government, a charitable organization, etc.), directly and/or indirectly, from the combination(s).

The method may use a financial statement(s) to account for at least the revenue and/or the asset. A value (e.g., a market capitalization) of the company(ies) and/or other(s) may be increased and/or other (e.g., maintained) from at least the combination(s), which may generate revenues and/or may be recognized as assets.

The charitable organization may be a non-profit organization and/or other. The government may be a federal government, a state government, a local government, a city government and/or other. The firm(s), for example, may be any of the law firms (e.g., one or more of the law firms) identified in any of the incorporated references. The company(ies) and/or other(s), for example, may be any of the assignees (e.g., one or more of the assignees) and/or the applicants (e.g., one or more of the applicants) identified in any of the incorporated references.

### Patent Claims and Patent Proceedings

Currently, the USPTO is under intense pressure to reduce a backlog of patent applications to be examined and speed the approval process, with quality as the first priority of its 21^{st} Century Strategic Plan.

The present patent document and/or part thereof may be used, for example, to enhance quality and/or productivity at the USPTO such as, for example, reduce (e.g., considerably reduce) the backlog of patent applications to be examined. The present patent document and/or part thereof may also be used, for example, to protect a company(ies), firm(s), individual(s) and/or other(s) (e.g., one or more of the assignees and/or the applicants identified in the incorporated references) from patent lawsuits.

The present patent document, which discloses a plurality of combinations, may be relied upon as prior art (e.g., by the USPTO and/or other patent offices, the courts, third parties, etc.) to render, alone or combined with other references, a plurality of patent claims as unpatentable and/or as invalid.

The present patent document, for example, may also be used, e.g., as prior art to support a resolution(s) of a patent proceeding(s) and/or other(s) (e.g., a patent dispute). The patent proceeding(s) may be an administrative proceeding(s), a court proceeding(s), an alternative dispute resolution proceeding(s), etc. The resolution(s) of the patent proceeding(s) may include an Office Action (e.g., a Final Office Action, a Notice of Allowance, etc.) issued by a patent office, a settlement of a litigation (e.g., patent litigation), etc.

The litigation, for example, may include at least one of (1) an asserted patent that is directed to the electrical arts, (2) an asserted patent that is directed to the mechanical arts, (3) an asserted patent that is directed to the chemical arts, (4) an asserted patent that is directed to the design arts and (5) an asserted patent that is directed to other arts. The patent litigation may include at least one of (1) an asserted utility patent, (2) an asserted design patent and (3) an asserted plant patent.

FIG. 34 illustrates a method that provides at least (1) a first reference and (2) a second reference. The first reference may include, in part or in whole, the disclosure of the present patent document. The second reference may include a patent claim(s). Each of the first reference and the second reference may be a patent, a patent application and/or other.

The method may rely upon—e.g., cite, consider, apply, etc.—directly and/or indirectly, at least the first reference and/or a part thereof—e.g., as cited art, prior art, etc.—so to at least one of: (1) reject and/or support a rejection of one or more of the patent claim(s), (2) invalidate and/or support an invalidity argument of one or more of the patent claim(s), (3) settle and/or support a settlement of a proceeding(s) involving one or more of the patent claim(s) and (4) decide and/or support the patentability and/or validity of one or more of the patent claim(s).

Each of the patent claim(s) may be directed to the electrical, mechanical, chemical, design and/or other arts. The rejection of the patent claim(s) may be an anticipation rejection, an obviousness rejection and/or other (e.g., non-establishment of novelty, non-establishment of inventive step, etc.), for example, issued by a patent office. The proceeding(s) may be an examination, a reexamination, arbitration, mediation, litigation and/or other(s) (e.g., a written opinion of an International Preliminary Examining Authority).

The above description and the drawings are intended to be illustrative, and not restrictive. The scope of the inventions should, therefore, be determined not with reference to the above description, but instead should be determined with reference to the appended claims along with their full scope of equivalents.

What is claimed is:

1. A company, the improvement comprising:
a prior art reference (1) including subject matter from U.S. patents issued from 1790 to 2008 and U.S. patent applications published from 2001 to 2008 and (2) configured to invalidate patent claims directed to the electrical arts so as to protect the company from a patent lawsuit,
wherein the prior art reference is a patent application.
